(19) United States
(12) Patent Application Publication
(10) Pub. No.: US 2024/0426983 A1
(43) Pub. Date: Dec. 26, 2024

(54) DISTANCE MEASURING DEVICE, DISTANCE MEASURING SYSTEM, AND DISTANCE MEASURING METHOD

(71) Applicant: SONY SEMICONDUCTOR SOLUTIONS CORPORATION, KANAGAWA (JP)

(72) Inventors: TAKESHI OYAKAWA, KANAGAWA (JP); AKITO SEKIYA, KANAGAWA (JP)

(21) Appl. No.: 18/708,015

(22) PCT Filed: Oct. 21, 2022
(86) PCT No.: PCT/JP2022/039209

§ 371 Date: May 7, 2024

(30) Foreign Application Priority Data
Nov. 15, 2021 (JP) 2021-185866

(51) Int. Cl. G01S 7/4865; G01S 7/4863; G01S 17/894

(52) U.S. Cl. CPC G01S 7/4865; G01S 7/4863; G01S 17/894

(57) ABSTRACT

A distance measuring device includes: a time counting section that counts a time from light emission by a light source to an incident timing at which photons are incident on a pixel; a processing section that performs correction processing on a count value output by the time counting section on the basis of a correction parameter set in advance; and a histogram generation section that generates a histogram on the basis of the count value corrected by the processing section.

### TECHNICAL FIELD

Embodiments according to the present disclosure relate to a distance measuring device, a distance measuring system, and a distance measuring method.

### BACKGROUND ART

A direct time of flight (ToF) sensor is one of distance measuring sensors that measure a distance to a subject. The Direct ToF sensor (hereinafter, simply referred to as a ToF sensor) directly measures a distance from time when light is emitted toward a subject and time when reflected light reflected from the subject is received.

In the ToF sensor, the time-of-flight of light from the time of irradiation with light to the time of reception of reflected light is converted into a count value corresponding to a distance by a time to digital converter (TDC). Light irradiation and reception are performed a plurality of times in order to remove the influence of disturbance light and multipath. Then, a histogram of count values for a plurality of times is generated, and a count value having the largest frequency value is output as a final count value (see, for example, Patent Document 1 to 3).

### CITATION LIST

### Patent Document

Patent Document 1: Japanese Patent Application Laid-Open No. 2020-73901
Patent Document 2: Japanese Unexamined Patent Application Publication No. 2021-507260
Patent Document 3: Japanese Patent Application Laid-Open No. 2021-1764

### SUMMARY OF THE INVENTION

### Problems to be Solved by the Invention

However, for example, if the position on the sensor, to which the distance measurement spot light (reflected light) returns, changes from a known position for some reason, a distance measurement error may occur.

Therefore, the present disclosure provides a distance measuring device, a distance measuring system, and a distance measuring method capable of suppressing a distance measurement error.

### Solutions to Problems

In order to solve the above problem, according to the present disclosure,
there is provided a distance measuring device including:
a time counting section that counts a time from light emission by a light source to an incident timing at which photons are incident on a pixel;
a processing section that performs correction processing on a count value output by the time counting section on the basis of a correction parameter set in advance; and
a histogram generation section that generates a histogram on the basis of the count value corrected by the processing section.

The processing section may include a compensation section that performs offset compensation processing on the count value output from the time counting section on the basis of an offset of the count value set in advance, and
the histogram generation section may generate the histogram on the basis of the count value subjected to the offset compensation processing.

The compensation section may perform the offset compensation processing on the count value output from the time counting section such that the count value at which a frequency value of the count value is maximized is same among a plurality of the pixels.

The compensation section may perform the offset compensation processing for each pixel on the basis of the offset corresponding to each pixel.

The compensation section may perform the offset compensation processing for each pixel group on the basis of the offset corresponding to one pixel included in the pixel group including a plurality of the pixels.

The processing section may include:
a measurement section that measures a reaction count that a light receiving element has reacted in response to incidence of photons to the pixel; and
a weighting processing section that performs weighting processing on a frequency value of the count value output by the time counting section on the basis of a reaction count measurement result of the measurement section for each of a plurality of the pixels, the reaction count set in advance, or a predetermined ratio of the reaction count set in advance between the plurality of pixels, and
the histogram generation section may generate the histogram on the basis of the frequency value subjected to the weighting processing.

The weighting processing section may perform the weighting processing on the frequency value such that a ratio of the reaction count measurement results among the plurality of pixels becomes the predetermined ratio.

In light receiving processing performed after reference light receiving processing, the weighting processing section may perform the weighting processing on the frequency value such that a ratio of the reaction count measurement results among the plurality of pixels is same as a ratio of the reaction count measurement results among the plurality of pixels in the reference light receiving processing.

The weighting processing section may:
perform the weighting processing on the frequency value such that a ratio of the reaction count measurement results among the plurality of pixels becomes a first predetermined ratio in reference light receiving processing; and
perform the weighting processing on the frequency value such that a ratio of the reaction count measurement results among the plurality of pixels becomes the first predetermined ratio in light receiving processing performed after the reference light receiving processing.

The reference light receiving processing may be calibration of the distance measuring device.

In second light receiving processing performed after first light receiving processing, the weighting processing section may perform the weighting processing on the frequency value in the second light receiving processing on the basis of the reaction count measurement result in the first light receiving processing.

The distance measuring device may further include a storage control section that stores the count value output from the time counting section in a count value storage section,
in which in third light receiving processing, the weighting processing section may perform the weighting processing on the frequency value in the third light receiving processing stored in the count value storage section on the basis of the reaction count measurement result in the third light receiving processing.

The distance measuring device may further include a determination section that determines whether or not the reaction count measurement result is within a predetermined range.

The time counting section may count a time from when the light source emits light to the incident timing for each pixel.

The distance measuring device may further include a first storage section that stores the correction parameter, and the processing section may perform the correction processing on the basis of the correction parameter stored in the first storage section.

According to the present disclosure,
there is provided a distance measuring system including:
a lighting device having a light source; and
a distance measuring device that receives reflected light in which light from the light source is reflected by an object,
in which the distance measuring device includes:
a time counting section that counts a time from light emission by the light source to an incident timing at which photons are incident on a pixel;
a processing section that performs correction processing on a count value output by the time counting section on the basis of a correction parameter set in advance; and
a histogram generation section that generates a histogram on the basis of the count value corrected by the processing section.

The distance measuring device may further include a first storage section that stores the correction parameter, and
the processing section may perform the correction processing on the basis of the correction parameter stored in the first storage section.

The distance measuring system may further include a second storage section that is disposed at a position different from a position at which the lighting device and the distance measuring device are disposed and stores the correction parameter,
in which the processing section may perform the correction processing on the basis of the correction parameter stored in the second storage section.

The lighting device may further include a third storage section that stores the correction parameter, and
the processing section may perform the correction processing on the basis of the correction parameter stored in the third storage section.

According to the present disclosure,
there is provided a distance measuring method including:
counting, by a time counting section, a time from light emission by a light source to an incident timing at which photons are incident on a pixel;
performing, by a processing section, correction processing on a count value output by the time counting section on the basis of a correction parameter set in advance; and
generating, by a histogram generation section, a histogram on the basis of the count value corrected by the processing section.

### BRIEF DESCRIPTION OF DRAWINGS

FIG. 1 is a block diagram illustrating an example of a configuration of a distance measuring system according to a first embodiment.

FIG. 2 is a block diagram illustrating an example of a schematic configuration of a light receiving device according to the first embodiment.

FIG. 3 is a block diagram illustrating an example of a basic configuration of the light receiving device according to the first embodiment.

FIG. 4 is a block diagram illustrating an example of arrangement of an offset storage section according to the first embodiment.

FIG. 5 is a circuit diagram illustrating an example of a configuration of a pixel according to the first embodiment.

FIG. 6 is a diagram illustrating an example of offset compensation processing by an offset compensation section according to the first embodiment.

FIG. 7 is a diagram illustrating an example of a shift of a light receiving position of spot light.

FIG. 8 is a diagram illustrating an example of a change in a histogram with respect to a change in a light receiving position of spot light according to the first embodiment.

FIG. 9 is a block diagram illustrating an example of calibration according to the first embodiment.

FIG. 10A is a diagram illustrating an example of arrangement of pixels according to the first embodiment.

FIG. 10B is a diagram illustrating an example of an offset stored in an offset storage section according to the first embodiment.

FIG. 11 is a block diagram illustrating an example of a configuration of an offset compensation section according to the first embodiment.

FIG. 12 is a diagram illustrating an example of expression of an offset amount by an offset compensation section according to the first embodiment.

FIG. 13 is a diagram illustrating an example of a change in a histogram with respect to a change in a light receiving position of spot light according to a comparative example.

FIG. 14 is a block diagram illustrating an example of a configuration of a distance measuring system according to a first modification of the first embodiment.

FIG. 15 is a block diagram illustrating an example of a configuration of a distance measuring system according to a second modification of the first embodiment.

FIG. 16 is a block diagram illustrating an example of a configuration of a distance measuring system according to a third modification of the first embodiment.

FIG. 17A is a diagram illustrating an example of arrangement of pixels according to a fourth modification of the first embodiment.

FIG. 17B is a diagram illustrating an example of an offset stored in an offset storage section according to a fourth modification of the first embodiment.

FIG. 18 is a block diagram illustrating an example of a configuration of an offset compensation section according to a fifth modification of the first embodiment.

FIG. 19 is a diagram illustrating an example of expression of an offset amount by an offset compensation section according to the fifth modification of the first embodiment.

FIG. 20 is a block diagram illustrating an example of a basic configuration of a light receiving device according to a second embodiment.

FIG. 21 is a diagram illustrating an example of weighting processing by a weighting processing section according to the second embodiment.

FIG. 22 is a block diagram illustrating an example of calibration according to the second embodiment.

FIG. 23 is a block diagram illustrating an example of a weight deciding section, a weighting processing section, and a peripheral configuration thereof according to the second embodiment.

FIG. 24 is a block diagram illustrating an example of a basic configuration of a light receiving device according to a first modification of the second embodiment.

FIG. 25 is a block diagram illustrating an example of calibration according to a second modification of the second embodiment.

FIG. 26 is a block diagram illustrating an example of a configuration of a weight deciding section, a weighting processing section, and a periphery configuration thereof according to the second modification of the second embodiment.

FIG. 27 is a block diagram illustrating an example of a configuration of a weight deciding section, a weighting processing section, and a periphery configuration thereof according to a third modification of the second embodiment.

FIG. 28 is a diagram for explaining a use example of a distance measuring system.

FIG. 29 is a block diagram illustrating an example of a schematic configuration of a vehicle control system.

FIG. 30 is an explanatory diagram illustrating an example of installation positions of an outside-vehicle information detection section and imaging sections.

### MODE FOR CARRYING OUT THE INVENTION

Hereinafter, embodiments of a distance measuring device, a distance measuring system, and a distance measuring method will be described with reference to the drawings. Although main components of the distance measuring device, the distance measuring system, and the distance measuring method will be mainly described below, the distance measuring device, the distance measuring system, and the distance measuring method may include components and functions that are not illustrated or described. The following description does not exclude components and functions that are not illustrated or described.

### First Embodiment

### [Configuration Example of Distance Measuring System]

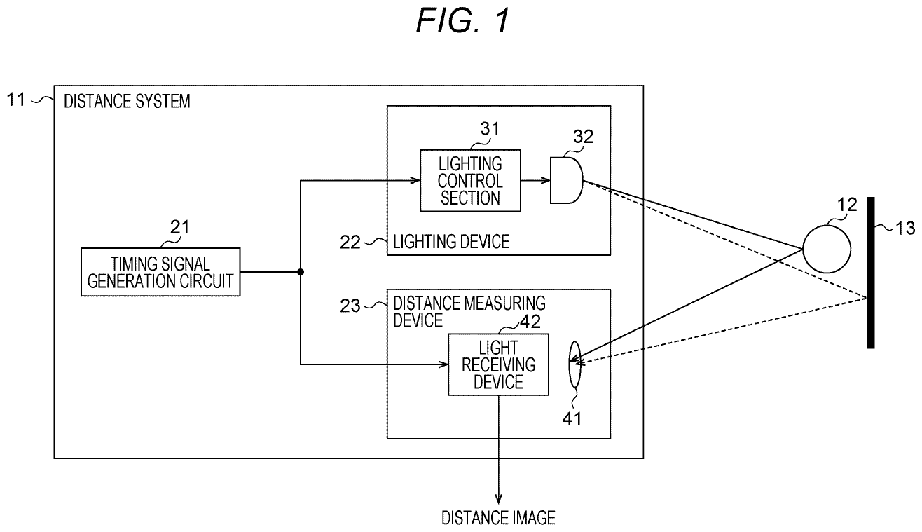

FIG. 1 is a block diagram illustrating an example of a configuration of a distance measuring system 11 according to a first embodiment.

The distance measuring system 11 is a system that measures the distance to an object 12 and an object 13 as measurement targets using, for example, the ToF method. Note that the distance measuring system 11 may be an independent system or may be a distance measuring module incorporated in another device (electronic device). The distance measuring system 11 includes a timing signal generation circuit 21, a lighting device 22, and a distance measuring device 23.

The timing signal generation circuit 21 generates a light emission timing signal for controlling the timing at which the lighting device 22 emits light, and supplies the light emission timing signal to the lighting device 22 and the distance measuring device 23.

The lighting device 22 includes a lighting control section 31 and a light source 32.

The lighting control section 31 causes the light source 32 to emit light in accordance with the light emission timing signal supplied from the timing signal generation circuit 21. For example, the light emission timing signal includes pulse signals of High (1) and Low (0), and the lighting control section 31 turns on the light source 32 when the light emission timing signal is High, and turns off the light source 32 when the light emission timing signal is Low.

The light source 32 emits light in a predetermined wavelength range under the control of the lighting control section 31. The light source 32 includes, for example, an infrared laser diode. Note that the type of the light source 32 and the wavelength range of the irradiation light can be arbitrarily set according to the application of the distance measuring system 11 and the like.

The distance measuring device 23 receives reflected light in which light (irradiation light) emitted from the lighting device 22 is reflected by the object 12 or the object 13, and calculates the distance to the object on the basis of the timing of receiving the reflected light.

The distance measuring device 23 includes a lens 41 and a light receiving device 42. The lens 41 forms an image of the incident light on the light receiving surface of the light receiving device 42. Note that the configuration of the lens 41 is arbitrary, and for example, the lens 41 can be configured by a plurality of lens groups.

The light receiving device 42 includes, for example, a pixel array in which pixels using a single photon avalanche diode (SPAD), an avalanche photodiode (APD), or the like as a light receiving element are two-dimensionally arranged in a matrix in a row direction and a column direction. The light receiving device 42 performs calculation to obtain the distance to the object 12 or the object 13 on the basis of the digital count value obtained by counting the time from when the lighting device 22 emits the irradiation light to when the light receiving device 42 receives the irradiation light and the speed of light, and generates and outputs a distance image in which the calculation result is stored in each pixel. The light emission timing signal indicating the timing at which the light source 32 emits light is also supplied from the timing signal generation circuit 21 to the light receiving device 42.

Note that, in the distance measuring system 11, the light emission of the light source 32 and the reception of the reflected light thereof are repeated a plurality of times (for example, several thousands to several tens of thousands of times), whereby the light receiving device 42 can generate and output a distance image from which the influence of disturbance light, multipath, or the like is removed.

### [Schematic Configuration Example of Light Receiving Device]

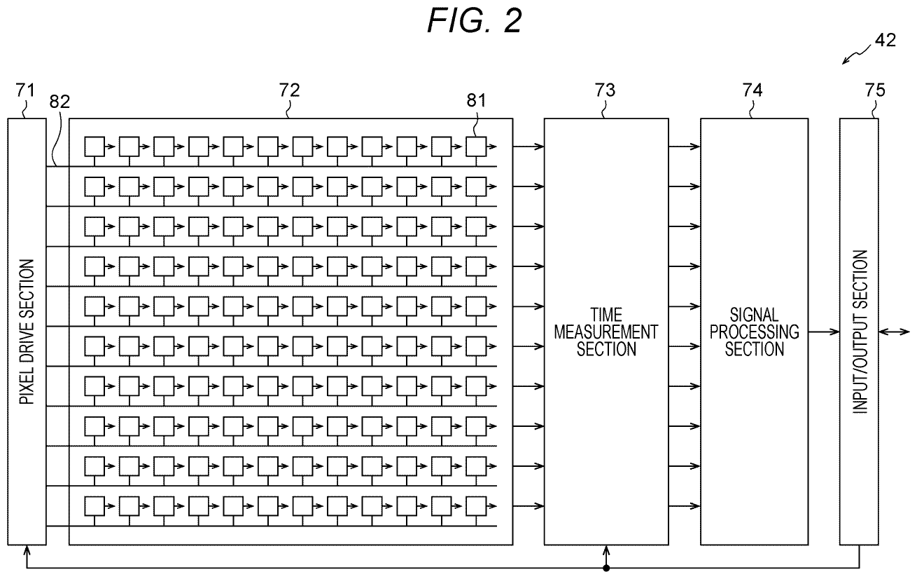

FIG. 2 is a block diagram illustrating an example of a schematic configuration of the light receiving device 42 according to the first embodiment.

The light receiving device 42 includes a pixel drive section 71, a pixel array 72, a time measurement section 73, a signal processing section 74, and an input/output section 75.

The pixel array 72 is configured such that pixels 81 that detect incidence of photons and output a detection signal indicating a detection result as a pixel signal are two-dimensionally arranged in a matrix in a row direction and a column direction. Here, the row direction refers to the arrangement direction of the pixels 81 in the horizontal direction, and the column direction refers to the arrangement direction of the pixels 81 in the vertical direction. In FIG. 2, the pixel array 72 is illustrated in a pixel array configuration of 10 rows and 12 columns due to paper restriction, but the number of rows and the number of columns of the pixel array 72 are not limited thereto and are arbitrary.

A pixel drive line 82 is wired in a horizontal direction for each pixel row with respect to the matrix-like pixel array of the pixel array 72. The pixel drive line 82 transmits a drive signal for driving the pixel 81. Note that, in FIG. 2, the pixel drive line 82 is illustrated as one wiring, but may include a plurality of wirings.

The pixel drive section 71 drives each pixel 81 by supplying a predetermined drive signal to each pixel 81 via the pixel drive line 82. Specifically, the pixel drive section 71 performs control such that at least some of the plurality of pixels 81 two-dimensionally arranged in a matrix form are set as active pixels and the remaining pixels 81 are set as inactive pixels at a predetermined timing corresponding to a light emission timing signal supplied from the outside via the input/output section 75. The active pixel is a pixel that detects incidence of a photon, and the inactive pixel is a pixel that does not detect incidence of a photon. Note that not only the pixel drive lines 82 wired in the horizontal direction but also pixel drive lines (not illustrated) wired in the vertical direction may be used, and the active pixels and the inactive pixels may be controlled by the logical product of the two. Of course, all the pixels 81 of the pixel array 72 may be the active pixels. The pixel signal generated by the active pixel in the pixel array 72 is input to the time measurement section 73. A detailed configuration of the pixel 81 will be described later.

The time measurement section 73 generates a count value corresponding to a time from when the light source 32 emits light to when the active pixel receives the light on the basis of the pixel signal supplied from the active pixel of the pixel array 72 and the light emission timing signal indicating the light emission timing of the light source 32. The light emission timing signal is supplied from the outside (timing signal generation circuit 21) to the time measurement section 73 via the input/output section 75.

The signal processing section 74 creates, for each pixel, a histogram of count values obtained by counting a time until reception of reflected light on the basis of light emission of the light source 32 repeatedly executed a predetermined number of times (for example, several thousands to several tens of thousands of times) and reception of the reflected light. Then, by detecting the peak of the histogram, the signal processing section 74 determines the time until the light emitted from the light source 32 is reflected by the object 12 or the object 13 and returns. The signal processing section 74 calculates the distance to the object on the basis of the digital count value obtained by counting the time until the light receiving device 42 receives the light and the speed of light.

The input/output section 75 generates a distance image in which the distance of each pixel detected by the signal processing section 74 is stored as a pixel value, and outputs a signal of the distance image (distance image signal) to the outside. Furthermore, the input/output section 75 acquires the light emission timing signal supplied from the timing signal generation circuit 21, and supplies the light emission timing signal to the pixel drive section 71 and the time measurement section 73.

The light receiving device 42 is configured as described above.

### [Basic Configuration Example of Light Receiving Device]

Before describing the detailed configuration of the light receiving device 42, a basic configuration example of the light receiving device as a premise of the light receiving device 42 will be described.

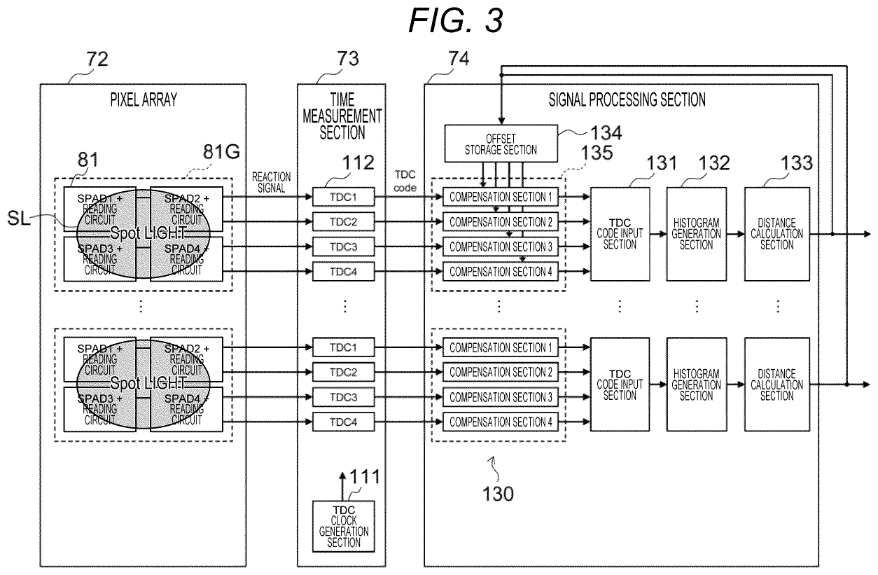

FIG. 3 is a block diagram illustrating an example of a basic configuration of the light receiving device according to the first embodiment.

In the basic configuration example of FIG. 3, each pixel 81 of the pixel array 72 includes a SPAD 101 and a reading circuit 102, the time measurement section 73 includes a TDC clock generation section 111 and a plurality of TDCs 112, and the signal processing section 74 includes a TDC code input section 131, a histogram generation section 132, a distance calculation section 133, an offset storage section 134, and an offset compensation section 135.

The SPAD (single photon avalanche photodiode) 101 is a light receiving element that performs avalanche amplification of generated electrons and outputs a signal when incident light is incident. Note that an APD can be used as the light receiving element instead of the SPAD.

The reading circuit 102 is a circuit that outputs a timing at which a photon is detected in the SPAD 101 as a detection signal PFout (FIG. 5).

Therefore, in the pixel 81, the reading circuit 102 reads the timing at which the incident light is incident on the SPAD 101, and outputs the timing to the TDC 112.

Furthermore, as illustrated in FIG. 3, one pixel group 81G includes a plurality of pixels 81. When one pixel group 81G receives the spot light SL, distance measurement of one point is performed.

One TDC clock generation section 111 is provided in the time measurement section 73, generates a TDC clock signal, and supplies the TDC clock signal to all the TDCs 112 in the time measurement section 73. The TDC clock signal is a clock signal for counting a time from when the TDC 112 emits the irradiation light to when the pixel 81 receives the irradiation light.

The time to digital converter (TDC) 112 counts time on the basis of the output of the reading circuit 102, and supplies a count value obtained as a result to the TDC code input section 131 of the signal processing section 74. Hereinafter, the value counted by the TDC 112 is referred to as a TDC code.

The TDC clock signal is supplied from the TDC clock generation section 111 to the TDC 112. The TDC 112 counts up the TDC code in order from 0 on the basis of the TDC clock signal. Then, the count-up is stopped when the detection signal PFout input from the reading circuit 102 indicates the timing at which the incident light is incident on the SPAD 101, and the TDC code in the final state is output to the TDC code input section 131.

Furthermore, the TDC 112 counts the time from the light emission of the light source to the incident timing for each pixel 81. In the example illustrated in FIG. 3, the TDC 112 is provided for each pixel 81.

A plurality of TDCs 112 is connected to an input stage of the TDC code input section 131 via the offset compensation section 135, and one histogram generation section 132 is connected to an output stage of the TDC code input section 131. The TDC code input section 131 inputs the TDC code output from any one of the plurality of TDCs 112 to the histogram generation section 132. That is, the histogram generation section 132 in the subsequent stage is provided in units of the plurality of pixels 81 of the pixel array 72. When the plurality of pixels 81 taken charge of by one histogram generation section 132 is referred to as a pixel group 81G (pixel group), the TDC code input section 131 causes the histogram generation section 132 to input a TDC code in a case where the TDC code is output from any of the plurality of TDCs 112 corresponding to the plurality of pixels 81 belonging to the pixel group 81G taken charge of by the histogram generation section 132.

The histogram generation section 132 generates a histogram of TDC codes, which is the time from when the light source 32 emits light to when it receives reflected light. In the distance measuring system 11, in one generation of the distance image, the light emission of the light source 32 and the reception of the reflected light thereof are repeated a predetermined number of times (for example, several thousands to several tens of thousands of times), so that a plurality of TDC codes is generated. The histogram generation section 132 generates a histogram for the plurality of generated TDC codes and supplies the histogram to the distance calculation section 133.

As described above, since the histogram generation section 132 generates a histogram on the basis of the TDC codes from the plurality of TDCs 112 belonging to the pixel group 81G taken charge of by the histogram generation section 132, in a case where a plurality of pixels of the pixel group 81G taken charge of by the histogram generation section 132 is set as active pixels at the same time, a histogram for the entire plurality of active pixels in the pixel group 81G is generated. On the other hand, in a case where any one pixel of the pixel group 81G taken charge of by the histogram generation section 132 is set as the active pixel, a histogram of one pixel set as the active pixel is generated.

Note that, in the basic configuration example of FIG. 3 and the configuration of the light receiving device 42 to be described later, in order to reduce the circuit area of the histogram generation section 132, the histogram generation section 132 is provided in units of pixel groups 81G including a plurality of pixels as described above, but needless to say, the histogram generation section 132 may be provided in units of pixels.

The distance calculation section 133 detects, for example, a TDC code having the maximum (peak) frequency value in the histogram supplied from the histogram generation section 132. The distance calculation section 133 performs calculation to obtain the distance to the object on the basis of the TDC code at the peak and the speed of light.

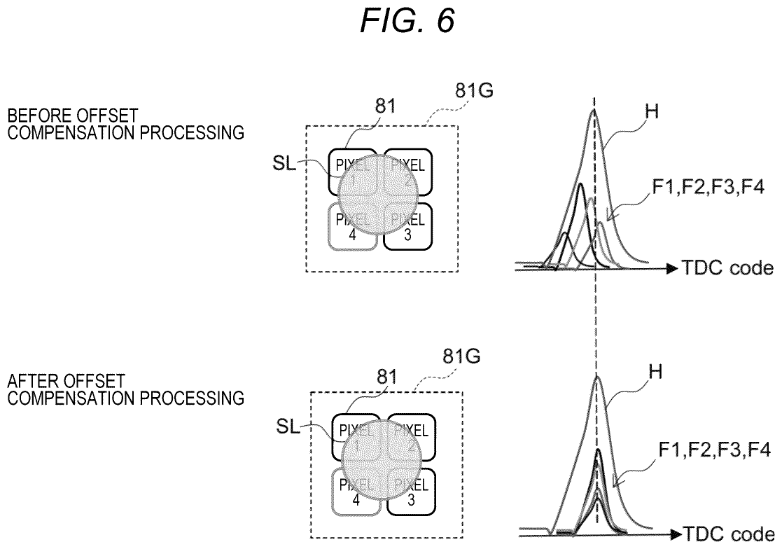

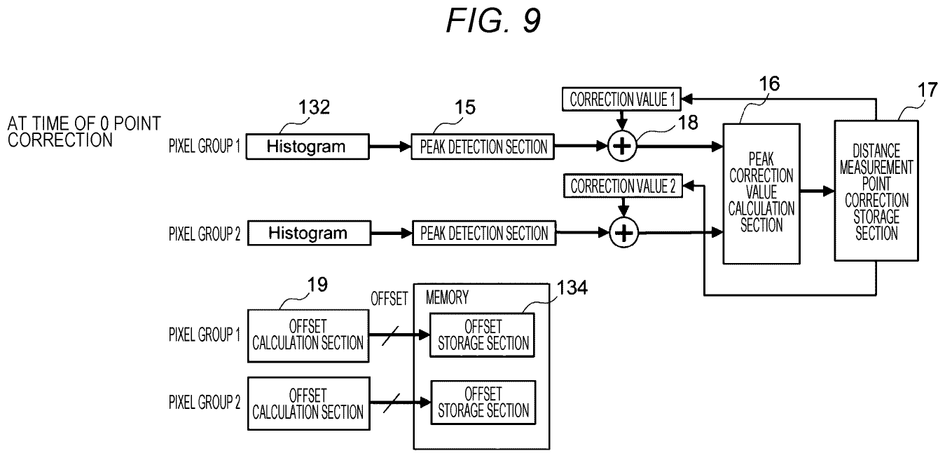

The offset storage section 134 stores an offset of each of the pixels 81. The offset is a correction parameter used for offset compensation (see FIG. 6). The offset is measured at the time of calibration (at the time of 0 point correction) illustrated in FIG. 9, for example, and is stored in the offset storage section 134. The calibration is a correction operation for performing a distance measurement operation for a certain constant distance in order to suppress variations in TOF time among the plurality of pixel groups 81G so that the distance measurement result becomes substantially constant in the plane of the pixel surface. Note that details of the calibration will be described later with reference to FIG. 9.

The offset compensation section 135 performs offset compensation processing on the TDC code (count value) output from the TDC 112 on the basis of a preset offset of the TDC code. The histogram generation section 132 generates a histogram on the basis of the TDC code subjected to the offset compensation processing. Note that details of the offset compensation processing will be described later with reference to FIG. 6.

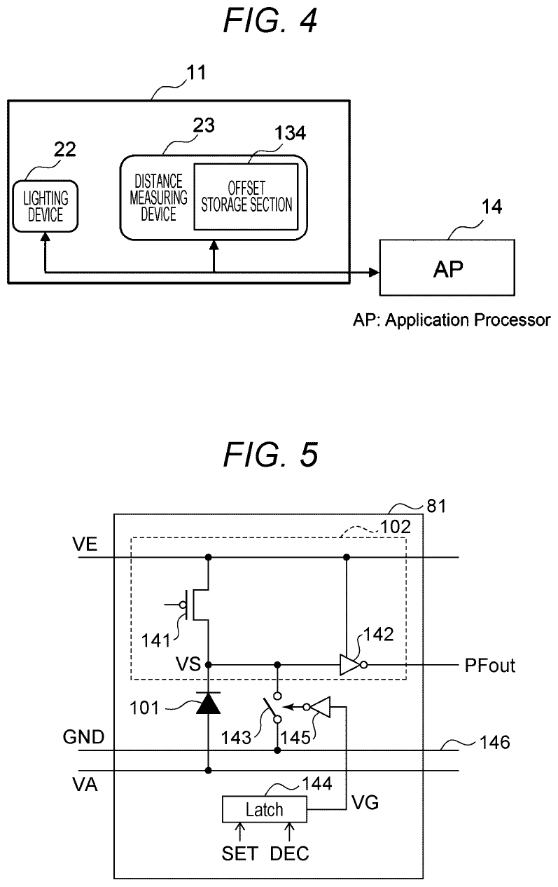

FIG. 4 is a block diagram illustrating an example of arrangement of the offset storage section 134 according to the first embodiment.

An application processor (AP) 14 is disposed outside the distance measuring system 11. The application processor 14 transmits a control command from the outside of the distance measuring system 11 to the lighting device 22 and the distance measuring device 23. As a result, the distance measuring system 11 operates.

As illustrated in FIG. 4, the offset storage section (first storage section) 134 is disposed in the distance measuring device 23 (signal processing section 74). That is, the distance measuring device 23 includes the offset storage section 134. As a result, the distance between the offset storage section 134 and the offset compensation section 135 can be shortened. As a result, the offset compensation processing can be performed more efficiently.

In the basic configuration example, a plurality of pixels 81 of the pixel array 72 and a plurality of sets of a plurality of TDCs 112, a TDC code input section 131, a histogram generation section 132, a distance calculation section 133, an offset storage section 134, and a plurality of offset compensation sections 135 corresponding thereto illustrated in FIG. 3 are provided. Then, in the entire light receiving device, histograms of the active pixels set in the pixel array 72 are generated in parallel (simultaneously), and the distance of each active pixel is calculated.

FIG. 5 is a circuit diagram illustrating an example of a configuration of the pixel 81 according to the first embodiment.

The pixel 81 in FIG. 5 includes a SPAD 101 and a reading circuit 102 including a transistor 141 and an inverter 142. Furthermore, the pixel 81 also includes a switch 143, a latch circuit 144, and an inverter 145. The transistor 141 includes a P-type MOS transistor.

A cathode of the SPAD 101 is connected to a drain of the transistor 141, and is connected to an input terminal of the inverter 142 and one end of the switch 143. An anode of the SPAD 101 is connected to a power supply voltage VA (hereinafter, also referred to as an anode voltage VA).

The SPAD 101 is a photodiode (single photon avalanche photodiode) that performs avalanche amplification of generated electrons and outputs a signal of a cathode voltage VS when incident light is incident. The power supply voltage VA supplied to the anode of the SPAD 101 is, for example, a negative bias (negative potential) of about −20 V.

The transistor 141 is a constant current source that operates in a saturation region, and performs passive quenching by acting as a quenching resistor. The source of the transistor 141 is connected to the power supply voltage VE, and the drain is connected to the cathode of the SPAD 101, the input terminal of the inverter 142, and one end of the switch 143. As a result, the power supply voltage VE is also supplied to the cathode of the SPAD 101. A pull-up resistor can also be used instead of the transistor 141 connected in series with the SPAD 101.

In order to detect light (photons) with sufficient efficiency, a voltage (excess bias) larger than the breakdown voltage VBD of the SPAD 101 is applied to the SPAD 101. For example, assuming that the breakdown voltage VBD of the SPAD 101 is 20 V and a voltage larger than that by 3 V is applied, the power supply voltage VE supplied to the source of the transistor 141 is 3 V.

Note that the breakdown voltage VBD of the SPAD 101 greatly changes depending on the temperature or the like. Therefore, the applied voltage applied to the SPAD 101 is controlled (adjusted) according to the change in the breakdown voltage VBD. For example, when the power supply voltage VE is a fixed voltage, the anode voltage VA is controlled (adjusted).

One end of the switch 143 at both ends is connected to the cathode of the SPAD 101, the input terminal of the inverter 142, and the drain of the transistor 141, and the other end is connected to a ground connection line 146 connected to the ground (GND). The switch 143 can include, for example, an N-type MOS transistor, and turns on and off the gating control signal VG, which is the output of the latch circuit 144, according to the gating inversion signal VG_I inverted by the inverter 145.

The latch circuit 144 supplies a gating control signal VG for controlling the pixel 81 to either an active pixel or an inactive pixel to the inverter 145 on the basis of the trigger signal SET supplied from the pixel drive section 71 and the address data DEC. The inverter 145 generates a gating inversion signal VG_I obtained by inverting the gating control signal VG, and supplies the gating inversion signal VG_I to the switch 143.

The trigger signal SET is a timing signal indicating a timing at which the gating control signal VG is switched, and the address data DEC is data indicating an address of a pixel to be set as the active pixel among the plurality of pixels 81 arranged in a matrix in the pixel array 72. The trigger signal SET and the address data DEC are supplied from the pixel drive section 71 via the pixel drive line 82.

The latch circuit 144 reads the address data DEC at a predetermined timing indicated by the trigger signal SET. Then, in a case where the pixel address of (the pixel 81 of) itself is included in the pixel address indicated by the address data DEC, the latch circuit 144 outputs a gating control signal VG of Hi(1) for setting the pixel 81 of itself as the active pixel. On the other hand, in a case where the pixel address of (the pixel 81 of) itself is not included in the pixel address indicated by the address data DEC, the gating control signal VG of Lo(0) for setting the pixel 81 of itself as an inactive pixel is output. Accordingly, in a case where the pixel 81 is set as an active pixel, the gating inversion signal VG_I of Lo(0) inverted by the inverter 145 is supplied to the switch 143. On the other hand, in a case where the pixel 81 is an inactive pixel, the gating inversion signal VG_I of Hi(1) is supplied to the switch 143. Thus, the switch 143 is turned off (disconnected) in a case where the pixel 81 is set as the active pixel and turned on (connected) in a case where it is set as the inactive pixel.

The inverter 142 outputs a Hi detection signal PFout when the cathode voltage VS as an input signal is Lo, and outputs a Lo detection signal PFout when the cathode voltage VS is Hi. The inverter 142 is an output section that outputs incidence of photons to the SPAD 101 as a detection signal PFout.

### [Offset Compensation Processing]

FIG. 6 is a diagram illustrating an example of offset compensation processing by the offset compensation section 135 according to the first embodiment. FIG. 6 illustrates a relationship between the position of the spot light SL with respect to the pixel 81 and the frequency value of the TDC code of each pixel 81. FIG. 6 illustrates a histogram H in which the frequency values F1 to F4 of the pixels 1 to 4 are summed. The upper part of FIG. 6 illustrates a state before the offset compensation processing. The lower part of FIG. 6 illustrates a state after the offset compensation processing.

In the example illustrated in FIG. 6, four pixels 81 are included in one pixel group 81G. The four pixels 81 illustrated in FIG. 6 are pixels 1 to 4.

Here, as illustrated in the upper part of FIG. 6, normally, the TDC codes in which the frequency values F1 to F4 peak are different for each pixel 1 to 4. The TDC code (peak position) at which the generated histogram H peaks is determined by the contribution of the frequency values F1 to F4.

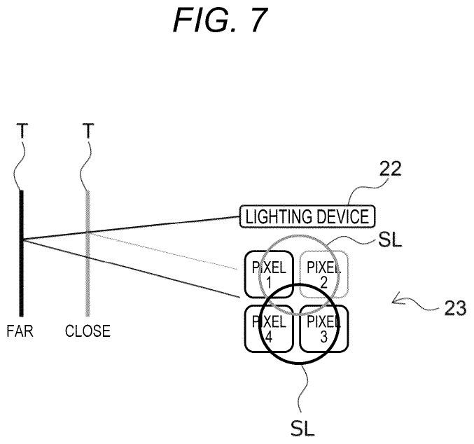

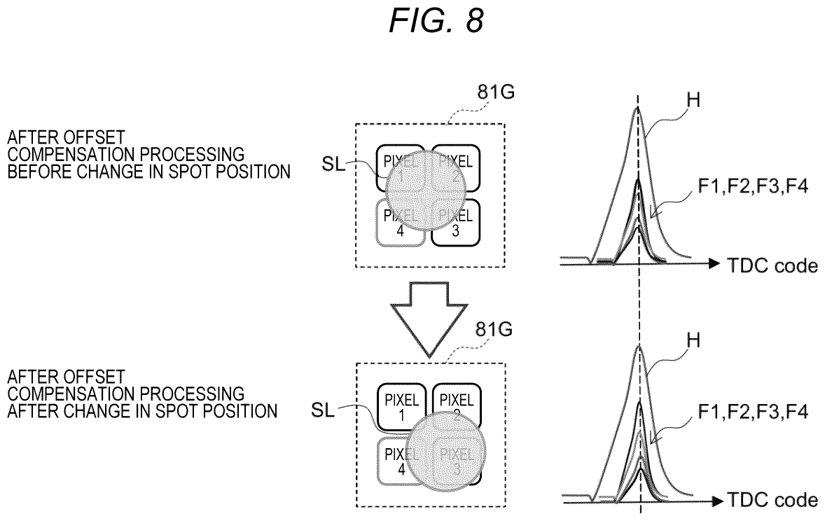

Therefore, the offset compensation section 135 performs offset compensation processing on the TDC codes of the respective pixels 1 to 4 so that the TDC codes having the peak frequency values are the same in the respective pixels 1 to 4. That is, the offset compensation section 135 performs the offset compensation processing on the TDC code output from the TDC 112 such that the TDC code having the maximum frequency value of the TDC code is the same among the plurality of pixels 81. As a result, a distance measurement error can be suppressed. Note that details of the distance measurement error will be described later with reference to FIGS. 7 and 8.

### [Distance Measurement Error]

FIG. 7 is a diagram illustrating an example of the shift of the light receiving position of the spot light SL.

In the example illustrated in FIG. 7, the light receiving position of the spot light SL changes between a case where the distance measurement target T is close to the distance measuring system 11 and the distance measurement distance is short and a case where the distance measurement target T is far from the distance measuring system 11 and the distance measurement distance is long. In a case where the distance measurement distance is short, photons of the spot light SL are more likely to be incident on the pixel 1 and the pixel 2 than the pixel 3 and the pixel 4. In this case, a histogram in which the contribution of the frequency values of the pixels 1 and 2 is larger than the contribution of the frequency values of the pixels 3 and 4 is generated. In a case where the distance measurement distance is long, photons of the spot light SL are more likely to be incident on the pixel 3 and the pixel 4 than the pixel 1 and the pixel 2. In this case, a histogram in which the contribution of the frequency values of the pixels 3 and 4 is larger than the contribution of the frequency values of the pixels 1 and 2 is generated.

The shift in the light receiving position of the spot light SL may be caused by, for example, a physical impact, a change in the physical position of the optical system with the lapse of time, and a change in the return position of the distance measurement light depending on the distance measurement distance (commonly called parallax).

FIG. 8 is a diagram illustrating an example of a change in the histogram with respect to a change in the light receiving position of the spot light SL according to the first embodiment. The upper part of FIG. 8 illustrates a state after the offset compensation processing and before the light receiving position of the spot light SL changes. The lower part of FIG. 8 illustrates a state after the offset compensation processing and after the change in the light receiving position of the spot light SL.

In the example illustrated in FIG. 8, the light receiving position of the spot light SL changes, and approaches the pixel 3 and is away from the pixel 1. In this case, the frequency value F3 of the pixel 3 increases, and the frequency value F1 of the pixel 1 decreases. That is, in the histogram H, the contribution of the frequency value F3 of the pixel 3 increases, and the contribution of the frequency value F1 of the pixel 1 decreases.

The TDC code (time) at which the generated histogram H peaks is substantially the same before and after the change in the light receiving position of the spot light SL. That is, even if the light receiving position of the spot light SL changes, the TDC code at which the histogram H peaks, that is, the value of the distance measured by the distance measuring device 23 hardly changes. This is because the TDC codes in which the frequency values F1 to F4 of the pixels 1 to 4 become peaks substantially coincide with each other by the offset compensation processing. That is, even if the contribution of the frequency value of any pixel changes, the TDC code (peak position) at which the generated histogram H peaks hardly changes.

### [Details of Calibration]

FIG. 9 is a block diagram illustrating an example of calibration according to the first embodiment. The calibration is performed, for example, at the time of shipment.

The distance measuring system 11 further includes a peak detection section 15, a peak correction value calculation section 16, a distance measurement point correction storage section 17, an adder/subtractor 18, and an offset calculation section 19 which are not illustrated in FIGS. 1 and 2. The peak detection section 15, the peak correction value calculation section 16, the distance measurement point correction storage section 17, the adder/subtractor 18, and the offset calculation section 19 are provided outside the signal processing section 74, for example.

The peak detection section 15 detects a TDC code at which the histogram generated by the histogram generation section 132 becomes a peak. The peak detection section 15 may be the distance calculation section 133.

The peak correction value calculation section 16 calculates a calibration correction value so as to suppress variation in distance measurement results among the plurality of pixel groups 81G. In the calibration, a distance measurement operation for a certain fixed distance is performed, and a calibration correction value is calculated such that a distance measurement result becomes substantially constant in a plane of a pixel surface. The calibration correction value is calculated for each pixel group 81G.

The distance measurement point correction storage section 17 stores the calibration correction value calculated by the peak correction value calculation section. For example, the calibration correction value is stored in the distance measurement point correction storage section 17 at the time of shipment.

The adder/subtractor 18 performs calibration correction processing at the time of actual operation, that is, in the distance measurement operation of the measurement target. The adder/subtractor 18 performs calibration correction processing on the TDC code detected by the peak detection section 15 on the basis of the calibration correction value stored in the distance measurement point correction storage section 17. The adder/subtractor 18 performs correction processing by, for example, adding or subtracting a calibration correction value to or from the TDC code.

The offset calculation section 19 calculates an offset from each TDC code of the pixel 81. The offset of a certain pixel 81 is decided, for example, on the basis of a difference between the reference value and the TDC code in which the frequency value in a certain pixel 81 peaks. The reference value is, for example, an average value, a minimum value, a maximum value, or the like of the TDC codes at which the TDC codes peak in all the pixels of the pixel array 72. Furthermore, the offset may be a value of the TDC code at which the TDC code in any pixel 81 in the pixel array 72 peaks.

The offset storage section 134 stores the respective offsets of the pixels 81 calculated by the offset calculation section 19. For example, the offset is stored in the offset storage section 134 at a timing when calibration is performed, that is, at the time of shipment.

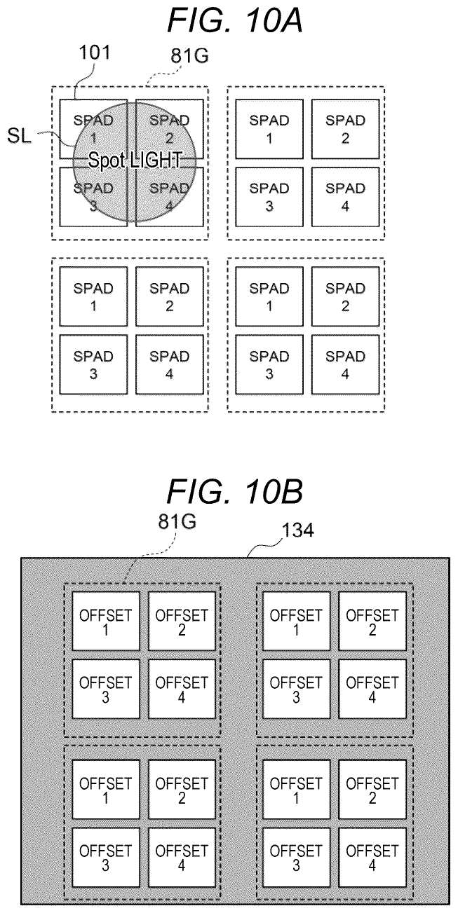

FIG. 10A is a diagram illustrating an example of arrangement of the pixels 81 according to the first embodiment. FIG. 10B is a diagram illustrating an example of an offset stored in the offset storage section 134 according to the first embodiment. Note that the positions of the pixels 81 are common in FIGS. 10A and 10B.

In the example illustrated in FIG. 10B, the offset storage section 134 stores offsets corresponding to all the pixels 81. Each of the plurality of pixels 81 is subjected to offset compensation processing by a plurality of corresponding offsets. That is, the offset compensation section 135 performs the offset compensation processing for each pixel 81 on the basis of the offset corresponding to each pixel 81. As a result, more accurate offset compensation processing can be performed on all the pixels 81.

### [Details of Offset Compensation Section]

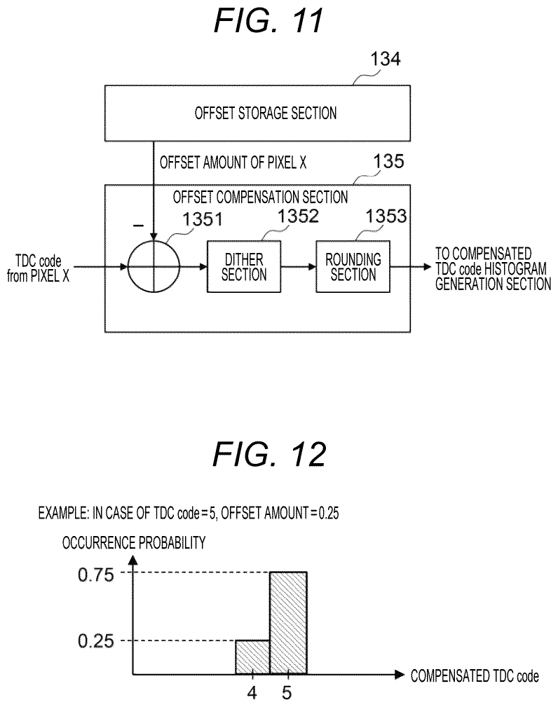

FIG. 11 is a block diagram illustrating an example of a configuration of the offset compensation section 135 according to the first embodiment.

The offset compensation section 135 includes an adder/subtractor 1351, a dither section 1352, and a rounding section 1353. Hereinafter, as an example, a case where the TDC code of the pixel X (for example, X=1 to 4) is 5 and the offset amount is 0.25 will be described. The TDC code output by the TDC 112 is usually an integer. The offset amount may include a decimal.

The adder/subtractor 1351 adds or subtracts the TDC code of the pixel X and the offset amount of the pixel X. The adder/subtractor 1351 outputs, for example, 4.75 (5−0.25).

The dither section 1352 expresses the TDC code subjected to the offset compensation processing by dithering. The value output from the adder/subtractor 1351 may include a decimal, such as 4.75. Bins of the histogram are usually integers and do not include decimals. In a case where the decimal is not properly handled, there is a possibility that the histogram is biased.

The dither section 1352 generates a random number according to the offset.

The rounding section 1353 outputs a TDC code of an integer (for example, 5 and 4) with a predetermined probability on the basis of the generated random number.

FIG. 12 is a diagram illustrating an example of expression of an offset amount by the offset compensation section 135 according to the first embodiment.

As illustrated in FIG. 12, the rounding section 1353 outputs the compensated TDC code of 5 with a probability of 75%, and outputs the compensated TDC code of 4 with a probability of 25%, for example. As a result, the rounding section 1353 can output the TDC code of 5 and the TDC code of 4 so that the average is 4.75. As a result, the decimal part of the offset can be more appropriately represented.

As described above, according to the first embodiment, the processing section 130 performs the correction processing on the TDC code (count value) output from the TDC 112 on the basis of the preset correction parameter. The histogram generation section 132 generates a histogram on the basis of the TDC code subjected to correction processing. More specifically, the processing section 130 includes, for example, an offset compensation section 135. The offset compensation section 135 performs offset compensation processing on the TDC code output from the TDC 112 on the basis of a preset offset. As a result, it is possible to suppress a distance measurement error caused by a change in the light receiving position of the spot light SL.

Furthermore, the offset compensation processing is performed on each frequency value of the pixels 81. Therefore, the offset compensation processing is performed before the histogram generation section 132 generates the histogram so that the frequency value of the pixel 81 can be processed.

Note that the timing at which the offset is stored in the offset storage section 134 is not necessarily limited to the timing of calibration, and may be another timing.

### COMPARATIVE EXAMPLE

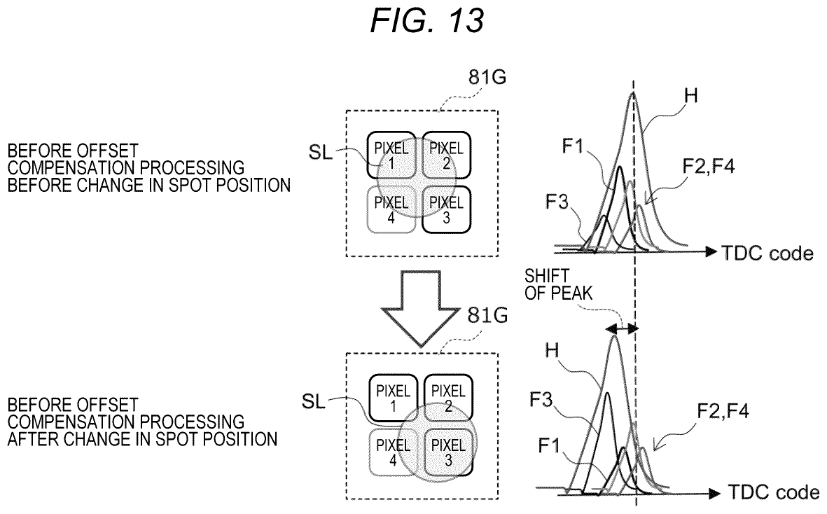

FIG. 13 is a diagram illustrating an example of the change in the histogram with respect to the change in the light receiving position of the spot light SL according to a comparative example. The comparative example is different from the first embodiment in that offset compensation processing is not performed. That is, in the comparative example, the offset storage section 134 and the offset compensation section 135 are not provided.

The upper part of FIG. 13 illustrates a state before the offset compensation processing and before the light receiving position of the spot light SL changes. The lower part of FIG. 8 illustrates a state before the offset compensation processing and after the light receiving position of the spot light SL changes.

As illustrated in the upper part of FIG. 13, since the offset compensation processing is not performed, the TDC codes in which the frequency values F1 to F4 peak are different for each pixel 1 to 4.

In the example illustrated in the lower part of FIG. 13, similarly to the lower part of FIG. 8, the light receiving position of the spot light SL changes, approaches the pixel 3, and is away from the pixel 1. Therefore, in the histogram H, the contribution of the frequency value F3 of the pixel 3 increases, and the contribution of the frequency value F1 of the pixel 1 decreases. As a result, the TDC code at which the generated histogram H becomes a peak shifts from the TDC code before the light receiving position of the spot light SL changes. As a result, even if the calibration is performed, the distance measurement result shifts, and there is a possibility that a distance measurement error occurs due to the shift of the light receiving position of the spot light SL.

On the other hand, in the first embodiment, before the generation of the histogram H, the TDC codes (peak positions) at which the frequency values F1 to F4 of the pixels 1 to 4 peak are substantially the same. As a result, even if the contribution of each of the frequency values F1 to F4 of the pixel 1 to 4 changes, the TDC code at which the generated histogram H peaks is substantially constant. As a result, it is possible to suppress a distance measurement error caused by a change in the light receiving position of the spot light SL.

### <First Modification of First Embodiment>

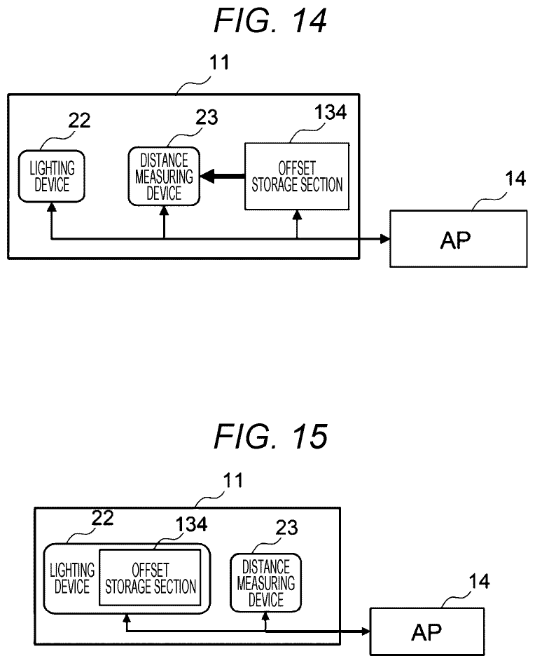

FIG. 14 is a block diagram illustrating an example of a configuration of a distance measuring system 11 according to a first modification of the first embodiment. The first modification of the first embodiment is different from the first embodiment in the arrangement of the offset storage section 134.

The offset storage section (second storage section) 134 is arranged at a position different from the lighting device 22 and the distance measuring device 23 in the distance measuring system 11.

The application processor 14 transmits a control command from the outside of the distance measuring system 11 to the lighting device 22, the distance measuring device 23, and the offset storage section 134. As a result, the distance measuring system 11 operates. The distance measuring device 23 acquires an offset from the offset storage section 134 outside the distance measuring device 23 in order to perform the offset compensation processing.

As in the first modification of the first embodiment, the arrangement of the offset storage section 134 may be changed. In this case, effects similar to those of the first embodiment can be obtained.

### <Second Modification of First Embodiment>

FIG. 15 is a block diagram illustrating an example of a configuration of a distance measuring system 11 according to a second modification of the first embodiment. The second modification of the first embodiment is different from the first embodiment in the arrangement of the offset storage section 134.

The offset storage section 134 is disposed in the lighting device 22. That is, the lighting device 22 includes the offset storage section (third storage section) 134. The distance measuring device 23 acquires an offset from the offset storage section 134 outside the distance measuring device 23 in order to perform the offset compensation processing.

As in the second modification of the first embodiment, the arrangement of the offset storage section 134 may be changed. In this case, effects similar to those of the first embodiment can be obtained.

### <Third Modification of First Embodiment>

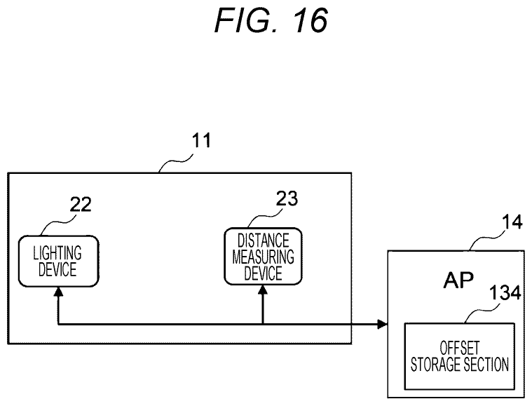

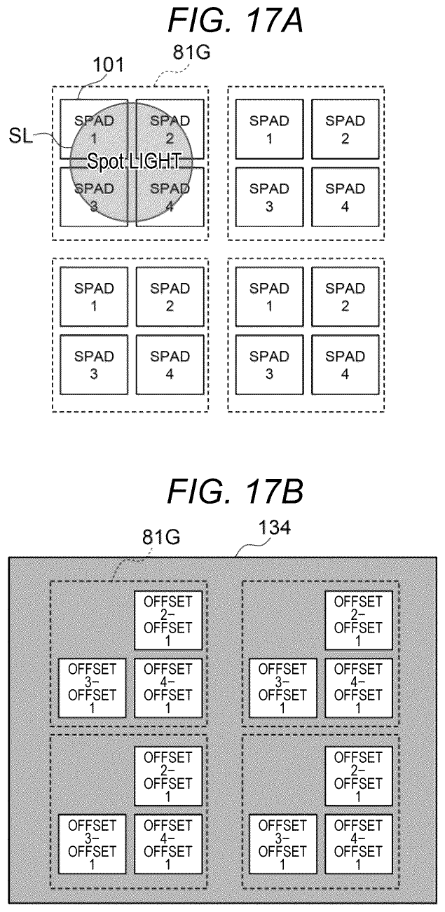

FIG. 16 is a block diagram illustrating an example of a configuration of a distance measuring system 11 according to a third modification of the first embodiment. The third modification of the first embodiment is different from the first embodiment in the arrangement of the offset storage section 134.

The offset storage section 134 is disposed in the application processor 14. That is, the application processor 14 includes the offset storage section 134. The application processor 14 transmits the offset amount stored in the offset storage section 134 to the distance measuring device 23. As a result, the distance measuring device 23 performs offset compensation processing.

As in the third modification of the first embodiment, the arrangement of the offset storage section 134 may be changed. In this case, effects similar to those of the first embodiment can be obtained.

### <Fourth Modification of First Embodiment>

FIG. 17A is a diagram illustrating an example of arrangement of pixels 81 according to a fourth modification of the first embodiment. FIG. 17B is a diagram illustrating an example of an offset stored in an offset storage section 134 according to a fourth modification of the first embodiment. The fourth modification of the first embodiment is different from the first embodiment in an offset storage method.

In the example illustrated in FIG. 17B, the offset storage section 134 stores the offset of one pixel 81 (SPAD 1) of the pixel group 81G. An offset (offset 1) of one pixel 81 (SPAD 1) is applied to the other pixels 81 included in the pixel group 81G. The plurality of pixels 81 is subjected to offset compensation processing in units of pixel groups 81G. That is, the offset compensation section 135 performs the offset compensation processing for each pixel group 81G on the basis of the offset corresponding to one pixel 81 included in the pixel group 81G including the plurality of pixels 81. As a result, it is possible to suppress a storage capacity that requires an offset.

As in the fourth modification of the first embodiment, the offset storage method may be changed. In this case, effects similar to those of the first embodiment can be obtained.

### <Fifth Modification of First Embodiment>

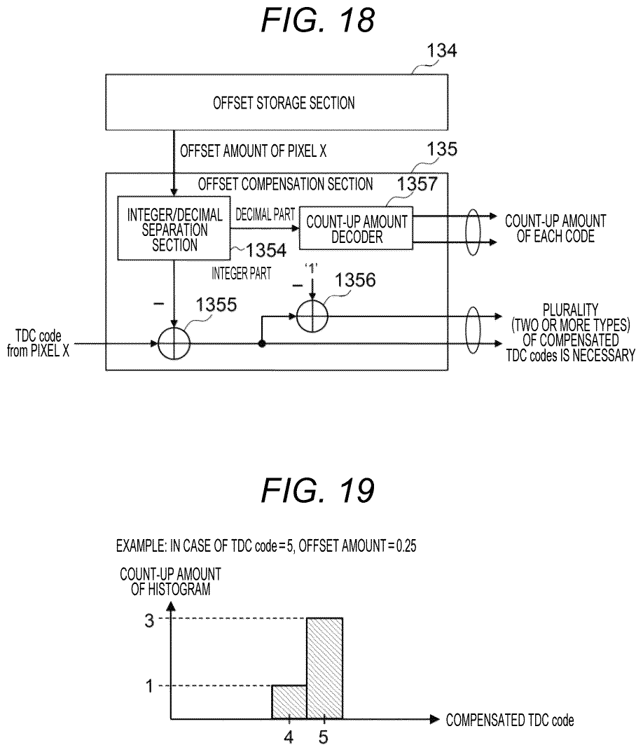

FIG. 18 is a block diagram illustrating an example of a configuration of an offset compensation section 135 according to a fifth modification of the first embodiment. The fifth modification of the first embodiment is different from the first embodiment in the method of offset compensation processing.

The offset compensation section 135 includes an integer/decimal separation section 1354, an adder/subtractor 1355, an adder/subtractor 1356, and a count-up amount decoder 1357. Hereinafter, as an example, a case where the TDC code of the pixel X (for example, X=1 to 4) is 5 and the offset amount is 0.25 will be described.

The integer/decimal separation section 1354 separates the integer part and the decimal part of the offset amount. The integer/decimal separation section 1354 outputs the integer part of the offset amount to the adder/subtractor 1355 and outputs the decimal part of the offset amount to the count-up amount decoder 1357. For example, the integer/decimal separation section 1354 outputs 5, which is an integer part, to the adder/subtractor 1355, and outputs 0.25, which is a decimal part, to the count-up amount decoder.

The adder/subtractor 1355 adds or subtracts the TDC code of the pixel X and an integer part of the offset amount of the pixel X. The adder/subtractor 1355 outputs, for example, 5 (5−0).

The adder/subtractor 1356 subtracts 1 from the output of the adder/subtractor 1356 and outputs the result. The adder/subtractor 1356 outputs, for example, 4 (5−1). Therefore, for the TDC code 5 input from the pixel X, the compensated TDC codes are 4 and 5.

The count-up amount decoder 1357 outputs the count-up amount of each code on the basis of the decimal part of the offset amount.

FIG. 19 is a diagram illustrating an example of expression of an offset amount by the offset compensation section 135 according to the fifth modification of the first embodiment.

As illustrated in FIG. 19, for example, the count-up amount decoder 1357 outputs a count-up amount of 1 to the compensated TDC code of 4 (the fourth bin) and outputs a count-up amount of 3 to the compensated TDC code of 5 (the fifth bin). In the examples illustrated in FIGS. 18 and 19, four counts up are performed for one input of the TDC code from the TDC 112. In this case, the average value of the compensated TDC codes in one count-up is 4.75. In this way, the offset TDC code 4.75 (5−0.25) can be expressed. When the count-up amount is input to the histogram generation section 132, a histogram is generated in consideration of the decimal part of the offset amount.

As in the fifth modification of the first embodiment, the method of the offset compensation processing may be changed. In this case, effects similar to those of the first embodiment can be obtained.

### Second Embodiment

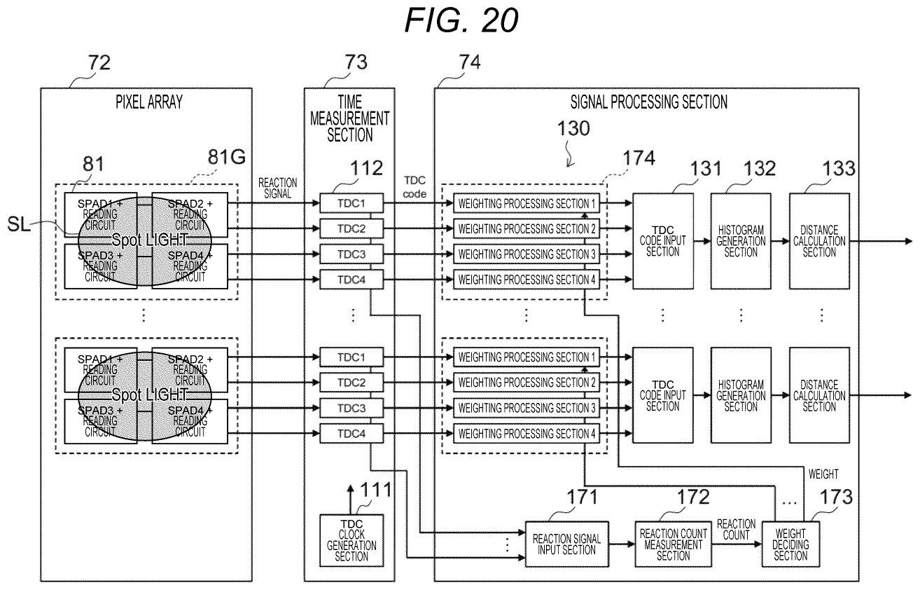

FIG. 20 is a block diagram illustrating an example of a basic configuration of the light receiving device 42 according to the second embodiment. The second embodiment is different from the first embodiment in that weighting processing is performed on a frequency value of a TDC code.

The signal processing section 74 further includes a reaction signal input section 171, a reaction count measurement section 172, a weight deciding section 173, and a plurality of weighting processing sections 174.

The light receiving device 42 in FIG. 20 performs two-stage light receiving processing including first light receiving processing of receiving reflected light for deciding a weight for each pixel and second light receiving processing of receiving reflected light for measuring a distance to a measurement target using the decided weight.

In the first light receiving processing, the TDC 112 outputs a reaction signal indicating that the SPAD 101 has reacted in response to the incidence of photons on the pixel 81 to the reaction signal input section 171. Here, the reaction of the SPAD 101 in response to the incidence of photons indicates that the Hi detection signal PFout is output from the reading circuit 102, more specifically, avalanche multiplication occurs in the SPAD 101 in response to the incidence of photons.

Furthermore, in the second light receiving processing, the TDC 112 counts the time from the light source 32 of the lighting device 22 emits light to the incident timing at which photons are incident on the SPAD 101, and outputs a TDC code which is the count result to the corresponding weighting processing section 174. The weighting processing sections 174 are provided on a one-to-one basis with respect to the TDC 112.

The TDC code output to the reaction signal input section 171 in the second light receiving processing has time information from when the light source 32 of the lighting device 22 emits light to the incident timing at which photons are incident on the SPAD 101.

A plurality of TDCs 112 is connected to an input stage of the reaction signal input section 171, and one reaction count measurement section 172 is connected to an output stage of the reaction signal input section 171. The reaction signal input section 171 inputs a TDC code output from any of the plurality of TDCs 112 to the reaction count measurement section 172. That is, the reaction count measurement section 172 in the subsequent stage is provided in units of the same pixel group 81G section as the histogram generation section 132. In a case where a TDC code is output from any of the plurality of TDCs 112 corresponding to the plurality of pixels 81 belonging to the pixel group 81G taken charge of by the reaction count measurement section 172, the reaction signal input section 171 inputs the TDC code to the reaction count measurement section 172. Note that the TDC 112 may directly calculate a reaction signal (the reaction count) having no time information from the TDC code and output the reaction signal to the reaction count measurement section 172. In this case, the reaction signal input section 171 may not be provided.

The reaction count measurement section 172 measures the reaction count of each pixel 81 belonging to the pixel group 81G on the basis of the reaction signal supplied from the reaction signal input section 171. That is, the reaction count measurement section 172 measures the reaction count at which the SPAD 102 has reacted in each pixel 81 belonging to the pixel group 81G, and supplies the measurement result to the weight deciding section 173.

The weight deciding section 173 decides the weight of each pixel 81 belonging to the pixel group 81G on the basis of the reaction count of each pixel 81 belonging to the pixel group 81G supplied from the reaction count measurement section 172.

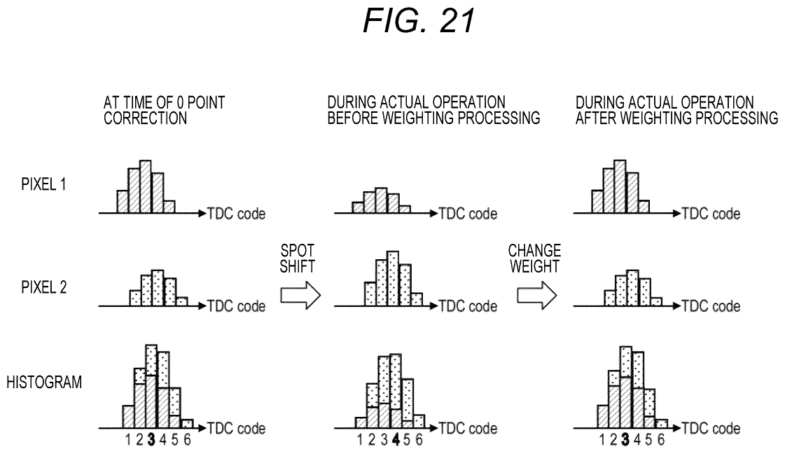

The weight deciding section 173 supplies the weight decided for each pixel 81 belonging to the pixel group 81G to the weighting processing section 174 to which the TDC code of the pixel 81 is input. Note that details of the weight deciding section 173 will be described later with reference to FIG. 21.

In the second light receiving processing, the weighting processing section 174 performs processing corresponding to the weight supplied from the weight deciding section 173 on the TDC code supplied from the TDC 112, and supplies the TDC code to the TDC code input section 131.

Specifically, the weighting processing section 174 outputs the TDC code supplied from the TDC 112 to the TDC code input section 131 the number of times corresponding to the weight according to the weight supplied from the weight deciding section 173.

The weighting processing section 174 performs weighting processing on the frequency value of the TDC code output from the TDC 112 on the basis of the reaction count measurement result of the reaction count measurement section 172 for each of the plurality of pixels 81 and the preset reaction count. Note that details of the weighting processing will be described later with reference to FIG. 21.

In this manner, since the weight decided by the weight deciding section 173 increases or decreases the number of times of the TDC code supplied to the histogram generation section 132 via the TDC code input section 131, the frequency value for each pixel 81 is increased or decreased.

Similarly to the first embodiment, the histogram generation section 132 generates a histogram and supplies the histogram to the distance calculation section 133. However, the TDC code of the number of times corresponding to the weight is supplied to the histogram generation section 132 by the weighting processing section 174. As a result, the TDC code subjected to the weighting processing for each pixel 81 is supplied. Therefore, the histogram generation section 132 generates a histogram on the basis of the frequency value subjected to the weighting processing.

### [Weighting Processing]

FIG. 21 is a diagram illustrating an example of weighting processing by the weighting processing section 174 according to the second embodiment. In FIG. 21, two pixels 81 will be described for simplification.

In the example illustrated in FIG. 21, in the calibration (at the time of 0 point correction), the frequency value of the pixel 1 indicates a peak with a TDC code of 3. The frequency value of the pixel 2 indicates a peak with a TDC code of 4. That is, as described with reference to FIG. 6, the TDC code having the peak frequency value is different for each of the pixels 1 and 2. The frequency value of the histogram generated by adding the frequency values of the pixel 1 and the pixel 2 indicates a peak with a TDC code of 3. This is because the contribution of the pixel 1 having a peak in the TDC code with the frequency value of 3 is larger than the contribution of the pixel 2 having a peak in the TDC code with the frequency value of 4.

Here, when a shift occurs in the light receiving position of the spot light SL during the actual operation, the contribution of the pixels 1 and 2 changes. In the example illustrated in FIG. 21, the contribution of the pixel 1 is small, and the contribution of the pixel 2 is large. In this case, the frequency value of the generated histogram greatly receives the contribution of the pixel 2, and indicates a peak with a TDC code of 4. As a result, the distance measurement result may shift, and a distance measurement error may occur due to the shift of the light receiving position of the spot light SL.

Therefore, the weighting processing section 174 performs weighting processing on the frequency values of the TDC codes output from the pixels 1 and 2 so that the ratio (weight) of the contribution of each of the pixels 1 and 2 maintains the state at the time of calibration (at the time of 0 point correction). That is, the weighting processing section 174 performs the weighting processing on the frequency value so that the ratio of the reaction count measurement results among the plurality of pixels 81 becomes a predetermined ratio. The predetermined ratio is a ratio of the preset reaction count between the plurality of pixels 81, and more specifically, is a ratio of the reaction count between the plurality of pixels 81 in the calibration. As a result, it is possible to suppress a distance measurement error due to the shift of the light receiving position of the spot light SL.

Note that, in order to know the ratio of the contribution of each of the pixels 81, it is necessary to measure all the reactions of a plurality of times (for example, several thousands to several tens of thousands of times). For example, the reaction count (parameter of the weighting processing) obtained in a certain light receiving processing is used for the weighting processing of the TDC code obtained in the next light receiving processing. That is, in the second light receiving processing executed after the first light receiving processing, the weighting processing section 174 performs the weighting processing on the frequency value in the second light receiving processing on the basis of the reaction count measurement result in the first light receiving processing.

The shift of the light receiving position of the spot light SL occurs, for example, when a secular change or a physical impact is received. In general, the reaction counts (contribution ratio) of each pixel 81 does not greatly change for each light receiving processing. Therefore, a distance measurement error that can be caused by a difference between the first light receiving processing for deciding the parameter of the weighting processing and the second light receiving processing for performing the weighting processing is small.

### [Details of Calibration]

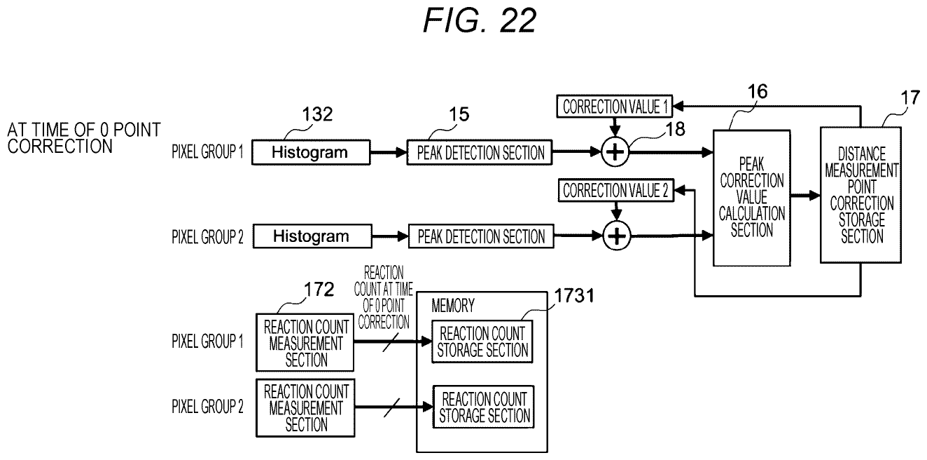

FIG. 22 is a block diagram illustrating an example of calibration according to the second embodiment.

The operation of calibration is the same as the operation of calibration in the first embodiment described with reference to FIG. 9.

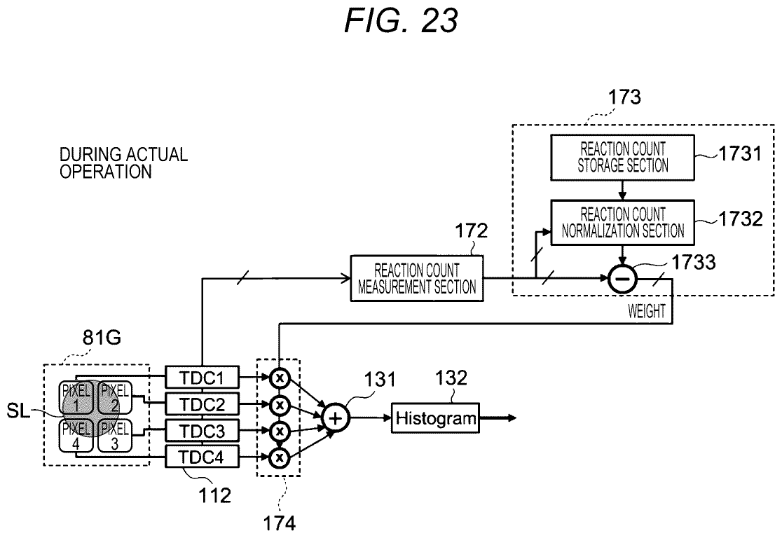

In the second embodiment, a reaction count storage section 1731 (see FIG. 23) stores the reaction count of each of the pixels 81 output from the reaction count measurement section 172 at the time of calibration. The reaction count is stored, for example, in the reaction count storage section 1731 at the time of shipment.

### [Details of Actual Operation]

FIG. 23 is a block diagram illustrating an example of a configuration of the weight deciding section 173, the weighting processing section 174, and a periphery configuration thereof according to the second embodiment.

For example, the reaction count measurement section 172 integrates the TDC code from the TDC 112 for each pixel 81, and measures the total reaction count.

The weight deciding section 173 includes a reaction count storage section 1731, a reaction count normalization section 1732, and an adder/subtractor 1733.

As described above, the reaction count storage section 1731 stores the reaction count at the time of calibration (at the time of 0 point correction), which is the reference light receiving processing of the distance measuring device 23.

In the first light receiving processing, the reaction count normalization section 1732 acquires the reaction counts of all reactions from the reaction count measurement section 172. In the first light receiving processing, the reaction count normalization section 1732 calculates a ratio between the reaction count stored in the reaction count storage section 1731 and the reaction count measurement result output from the reaction count measurement section 172, and decides a parameter of the weighting processing. As a result, the parameter of the weighting processing can be decided so as to maintain the ratio of the contribution of the frequency value between the pixels 81 at the time of calibration.

In the second light receiving processing, the adder/subtractor 1733 adds/subtracts the reaction count measurement result output from the reaction count measurement section 172 and the parameter of the weighting processing decided by the reaction count normalization section 1732, and outputs the weight.

The weighting processing section 174 includes a multiplier. For example, the weighting processing section 174 performs weighting processing so as to control the number of outputs of the TDC code by multiplying the frequency value of the TDC code by the weight decided by the weight deciding section 173.

The reaction count measurement section 172, the weight deciding section 173, and the weighting processing section 174 perform the above processing for each pixel 81. That is, in the light receiving processing (actual operation) performed after the reference light receiving processing (calibration), the weighting processing section 174 performs the weighting processing on the frequency value of the TDC code such that the ratio of the reaction count measurement results among the plurality of pixels 81 is the same as the ratio of the reaction count measurement results among the plurality of pixels 81 in the calibration.

As described above, according to the second embodiment, the processing section 130 performs the correction processing on the TDC code (count value) output from the TDC 112 on the basis of the preset correction parameter. More specifically, the processing section 130 includes, for example, the reaction count measurement section 172, the weight deciding section 173, and the weighting processing section 174. The weighting processing section 174 performs weighting processing on the frequency value of the TDC code output from the TDC 112 on the basis of the reaction count measurement result of the reaction count measurement section 172 for each of the plurality of pixels 81 and the preset reaction count. As a result, it is possible to suppress a distance measurement error due to the shift of the light receiving position of the spot light SL.

As in the second embodiment, weighting processing may be performed on the frequency value of the TDC code. In this case, effects similar to those of the first embodiment can be obtained.

Furthermore, in the second embodiment, the reaction count storage section 1731 is disposed in the distance measuring device 23. However, the present invention is not limited thereto, and the arrangement of the reaction count storage section 1731 may be changed similarly to the offset storage section 134 in the first to third modifications of the first embodiment.

### <First Modification of Second Embodiment>

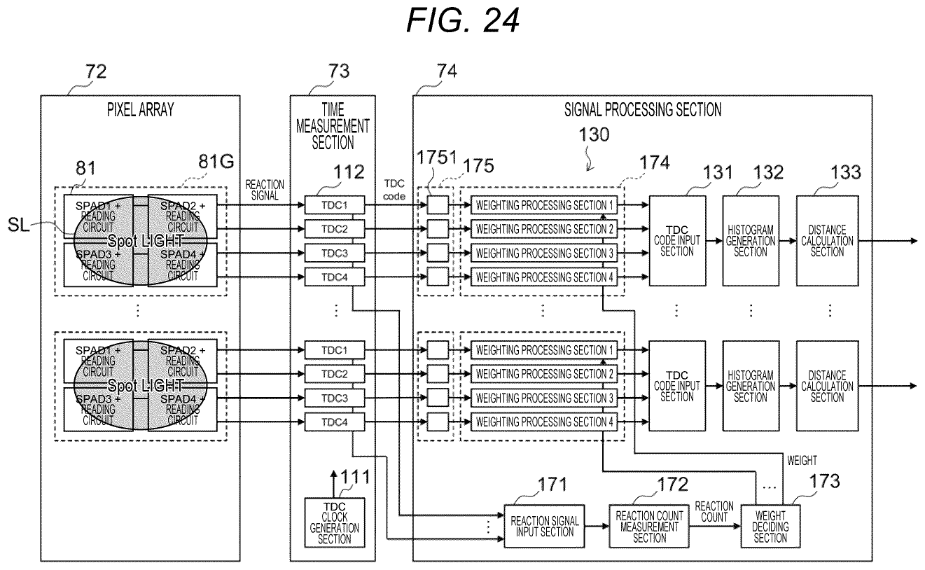

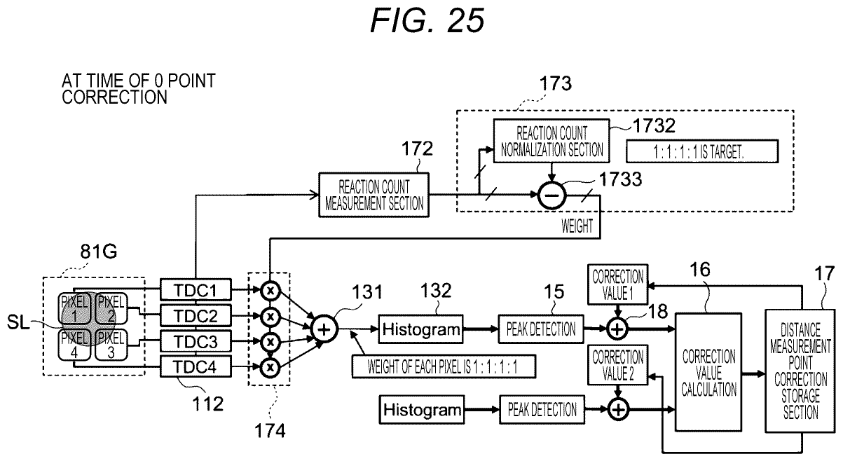

FIG. 24 is a block diagram illustrating an example of a basic configuration of a light receiving device 42 according to a first modification of the second embodiment. The first modification of the second embodiment is different from the second embodiment in that first light receiving processing for deciding a weight and second light receiving processing for performing weighting processing are the same.

The signal processing section 74 further includes a storage control section 175.

The storage control section 175 includes a TDC code storage section 1751. The storage control section 175 stores the TDC code output from the TDC 112 in the TDC code storage section (count value storage section) 1751.

In certain light receiving processing (third light receiving processing), the weighting processing section 174 performs weighting processing on the frequency value of the TDC code in certain light receiving processing stored in the TDC code storage section 1751 on the basis of the reaction count measurement result in certain light receiving processing. As a result, the light receiving processing for deciding the parameter of the weighting processing and the light receiving processing for performing the weighting processing can be made the same. In addition, weighting processing can be performed in one light receiving processing.

As in the first modification of the second embodiment, the first light receiving processing for deciding the weight and the second light receiving processing for performing the weighting processing may be the same. In this case, effects similar to those of the second embodiment can be obtained.

### <Second Modification of Second Embodiment>

FIG. 25 is a block diagram illustrating an example of calibration according to a second modification of the second embodiment. The second modification of the second embodiment is different from the second embodiment in that weighting processing is performed at the time of calibration.

In the example illustrated in FIG. 25, the reaction count storage section 1731 is not provided.

The weight deciding section 173 decides the parameter of the weighting processing so as to be the first predetermined ratio. The first predetermined ratio is, for example, 1:1:1:1.

In the reference light receiving processing (calibration), the weighting processing section 174 performs the weighting processing on the frequency value of the TDC code such that the ratio of the reaction count measurement results among the plurality of pixels 81 becomes the first predetermined ratio.

In this case, the histogram is generated in a state where the ratio of the reaction count of the pixels 81 is 1:1:1:1. Furthermore, the calibration processing is also performed in a state where the ratio of the reaction count of the pixels 81 is 1:1:1:1.

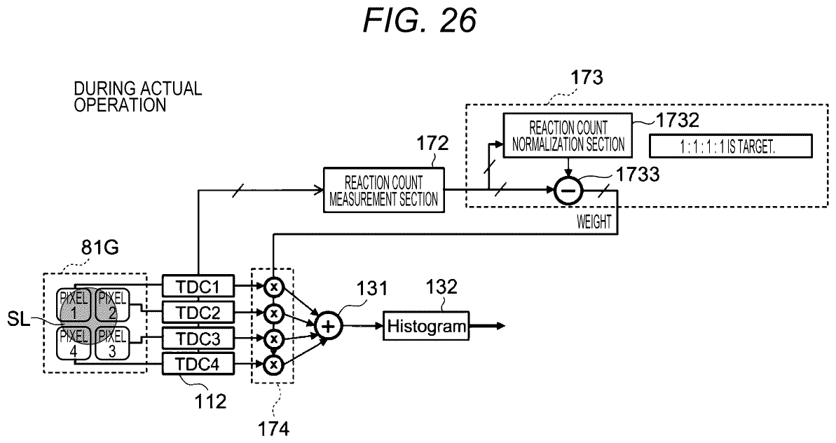

FIG. 26 is a block diagram illustrating an example of a configuration of a weight deciding section 173, a weighting processing section 174, and a periphery configuration thereof according to the second modification of the second embodiment.

In the first light receiving processing, the weight deciding section 173 decides the parameter of the weighting processing such that the reaction count measurement result of each of the pixels 81 becomes a preset first predetermined ratio (1:1:1:1).

The weighting processing section 174 performs weighting processing on the frequency value of the TDC code output from the TDC 112 on the basis of the reaction count measurement result of the reaction count measurement section 172 for each of the plurality of pixels 81 and a predetermined ratio of the preset reaction count among the plurality of pixels 81.

In the light receiving processing performed after the first light receiving processing, the weighting processing section 174 performs the weighting processing on the frequency value of the TDC code so that the ratio of the reaction count measurement results among the plurality of pixels 81 becomes the first predetermined ratio. The weight deciding section 173 decides the parameter of the weighting processing such that the ratio of the reaction count of the pixel 81 becomes the first predetermined ratio in both the calibration and the actual operation. That is, since the target ratio of the weighting processing is the same as the target ratio at the time of calibration, it is not necessary to store the measurement result of the reaction count at the time of calibration. As a result, it is not necessary to provide the reaction count storage section 1731 as compared with the second embodiment.

As in the second modification of the second embodiment, weighting processing may also be performed in calibration. In this case, effects similar to those of the second embodiment can be obtained.

### <Third Modification of Second Embodiment>

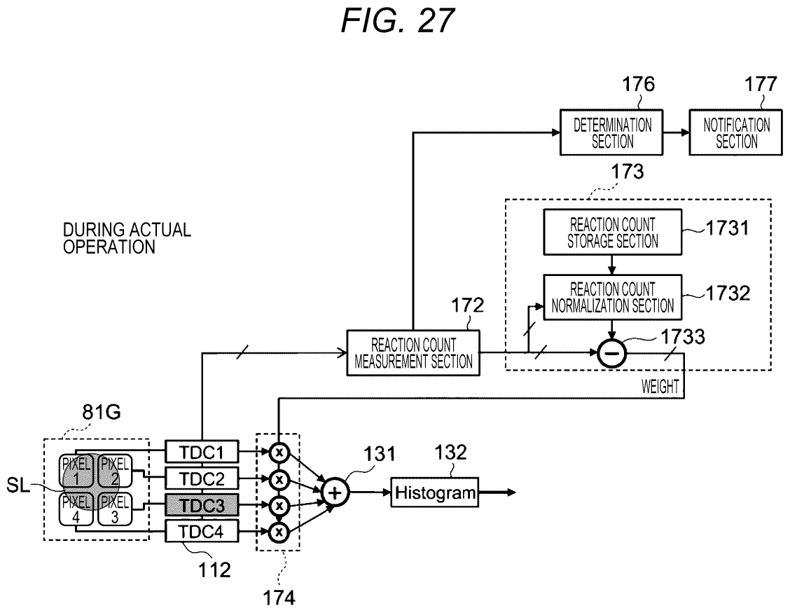

FIG. 27 is a block diagram illustrating an example of a configuration of a weight deciding section 173, a weighting processing section 174, and a periphery configuration thereof according to a third modification of the second embodiment. The third modification of the second embodiment is different from the second embodiment in that abnormality detection is performed on the basis of the reaction count.

The signal processing section 74 further includes a determination section 176 and a notification section 177.

The determination section 176 determines whether or not the measurement result of the reaction count measurement section 172 exceeds a predetermined range. For example, in a case where the reaction count of the pixel 3 illustrated in FIG. 27 is too small or too large, there is a possibility that the reliability of the reaction of the pixel 81 is lowered due to occurrence of some abnormality in the pixel 81 or the like.

The notification section 177 notifies the determination result. In the example illustrated in FIG. 27, the notification section 177 notifies that the reliability of the reaction obtained from the pixel 3 is low. As a result, it is possible to prompt the user to recalibrate or to notify the user of the failure.

As in the third modification of the second embodiment, abnormality detection may be performed on the basis of the reaction count. In this case, effects similar to those of the second embodiment can be obtained.

### <Use Example of Distance Measuring System>

The present technology is not limited to application to a distance measuring system. That is, the present technology can be applied to, for example, all electronic devices such as smartphones, tablet terminals, mobile phones, personal computers, game machines, television receivers, wearable terminals, digital still cameras, and digital video cameras. The above-described distance measuring device 23 may be in a form of a module in which the lens 41 and the light receiving device 42 are packaged together, or the lens 41 and the light receiving device 42 may be configured separately and only the light receiving device 42 may be configured as one chip.

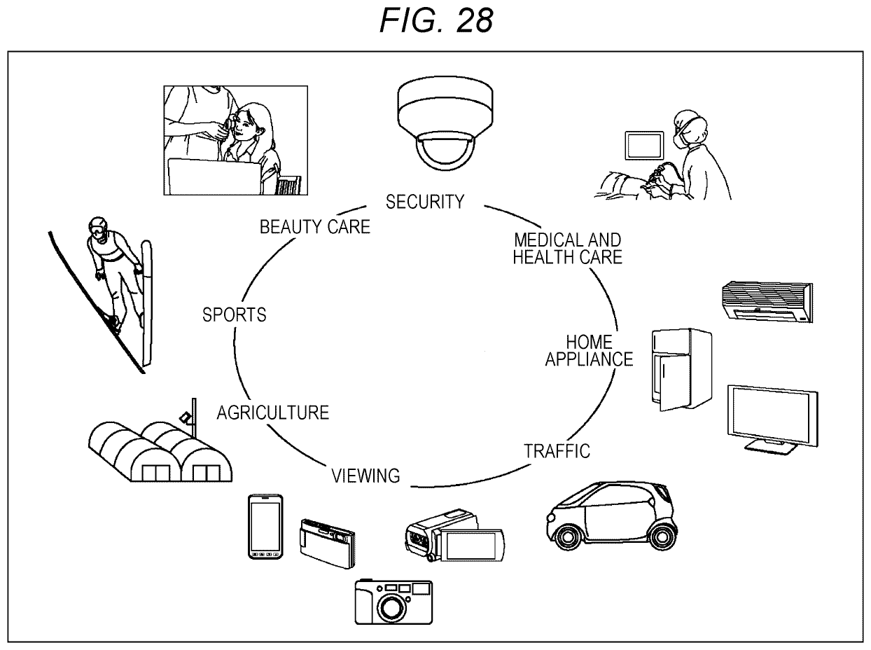

FIG. 28 is a diagram illustrating a use example of the above-described distance measuring system 11 or distance measuring device 23.

The above-described distance measuring system 11 can be used, for example, in various cases of sensing light such as visible light, infrared light, ultraviolet light, and X-rays as described below.
A device provided to be used for viewing, such as a digital camera or a portable device with a camera function, the device taking an image
A device for traffic purpose such as an in-vehicle sensor that takes images of the front, rear, surroundings, interior and the like of an automobile, a monitoring camera that monitors traveling vehicles and roads, and a distance measuring sensor that measures a distance between vehicles and the like for safe driving such as automatic stop, recognition of a driver's condition and the like
A device for home appliance such as a television (TV), a refrigerator, and an air conditioner that images a user's gesture and performs device operation according to the gesture
A device for medical and health care use such as an endoscope and a device that performs angiography by receiving infrared light
A device for security use such as a security monitoring camera and an individual authentication camera
A device used for beauty care, such as a skin condition measuring instrument for imaging skin, and a microscope for imaging the scalp
A device used for sports, such as an action camera or a wearable camera for sports applications or the like
A device used for agriculture, such as a camera for monitoring a condition of a field or crop.

### <Application Example to Moving Body>

The technology according to the present disclosure (the present technology) can be applied to various products. For example, the technology according to the present disclosure may also be implemented as a device mounted on any type of moving body such as an automobile, an electric automobile, a hybrid electric automobile, a motorcycle, a bicycle, a personal mobility, an airplane, a drone, a ship, and a robot.

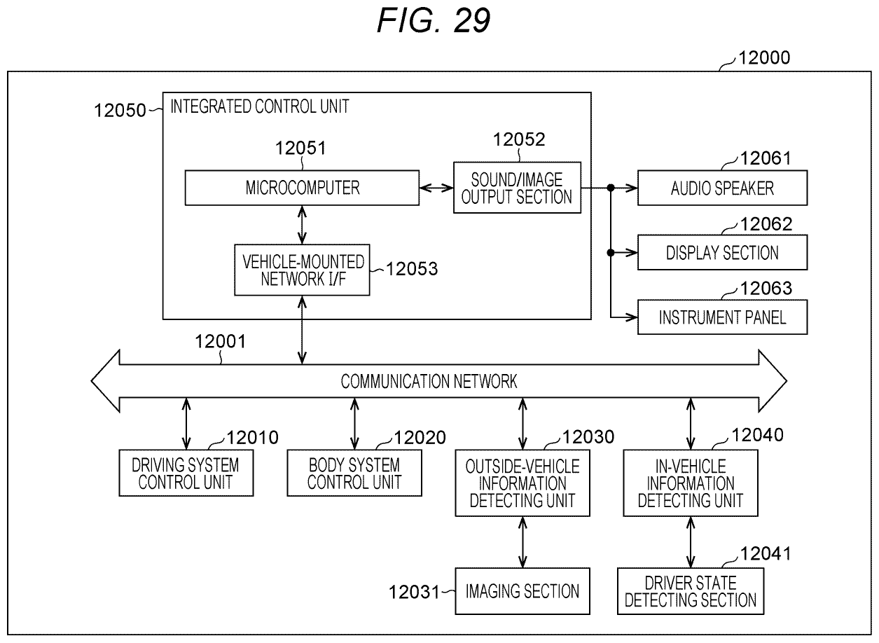

FIG. 29 is a block diagram illustrating a schematic configuration example of a vehicle control system as an example of a moving body control system to which the technology according to the present disclosure can be applied.

The vehicle control system 12000 includes a plurality of electronic control units connected to each other via a communication network 12001. In the example illustrated in FIG. 29, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 29, an audio speaker 12061, a display section 12062, and an instrument panel 12063 are illustrated as the output device. The display section 12062 may, for example, include at least one of an on-board display and a head-up display.

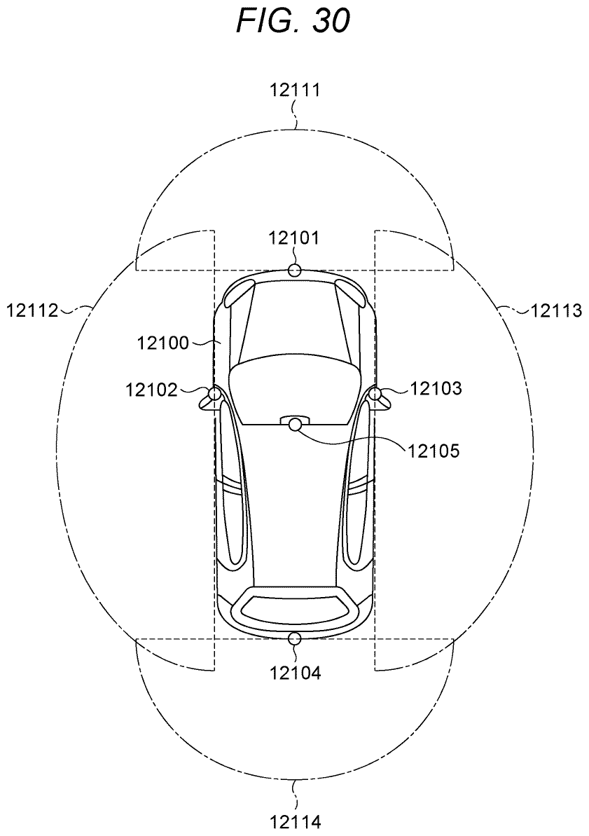

FIG. 30 is a diagram illustrating an example of the installation position of the imaging section 12031.

In FIG. 30, imaging sections 12101, 12102, 12103, 12104, and 12105 are included as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 30 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging sections 12031, 12101, 12102, 12103, 12104, 12105, and the like among the above-described configurations. Specifically, for example, the distance measuring system 11 in FIG. 1 can be applied to these imaging sections. The imaging sections 12031, 12101, 12102, 12103, 12104, and 12105 are, for example, LIDARs, and are used for detecting an object around the vehicle 12100 and a distance to the object. Then, by applying the technology according to the present disclosure, detection accuracy of an object and a distance to the object around the vehicle 12100 is improved. As a result, for example, a vehicle collision warning can be performed at an appropriate timing, and a traffic accident can be prevented.

Note that, in the present specification, a system means an assembly of a plurality of components (devices, modules (parts), and the like), and it does not matter whether or not all the components are located in the same housing. Therefore, a plurality of devices housed in separate housings and connected via a network and one device in which a plurality of modules is housed in one housing are both systems.

Furthermore, the embodiments of the present technology are not limited to the embodiments described above, and various modifications may be made without departing from the scope of the present technology.

Note that the present technology may have the following configurations.

(1)

A distance measuring device including:
a time counting section that counts a time from light emission by a light source to an incident timing at which photons are incident on a pixel;
a processing section that performs correction processing on a count value output by the time counting section on the basis of a correction parameter set in advance; and
a histogram generation section that generates a histogram on the basis of the count value corrected by the processing section.
   (2)

The distance measuring device according to (1), in which
the processing section includes a compensation section that performs offset compensation processing on the count value output from the time counting section on the basis of an offset of the count value set in advance, and
the histogram generation section generates the histogram on the basis of the count value subjected to the offset compensation processing.
   (3)

The distance measuring device according to (2), in which the compensation section performs the offset compensation processing on the count value output from the time counting section such that the count value at which a frequency value of the count value is maximized is same among a plurality of the pixels.

(4)

The distance measuring device according to (2) or (3), in which the compensation section performs the offset compensation processing for each pixel on the basis of the offset corresponding to each pixel.

(5)

The distance measuring device according to (2) or (3), in which the compensation section performs the offset compensation processing for each pixel group on the basis of the offset corresponding to one pixel included in the pixel group including a plurality of the pixels.

(6)

The distance measuring device according to (1), in which
the processing section includes:
a measurement section that measures a reaction count that a light receiving element has reacted in response to incidence of photons to the pixel; and
a weighting processing section that performs weighting processing on a frequency value of the count value output by the time counting section on the basis of a reaction count measurement result of the measurement section for each of a plurality of the pixels, the reaction count set in advance, or a predetermined ratio of the reaction count set in advance between the plurality of pixels, and
the histogram generation section generates the histogram on the basis of the frequency value subjected to the weighting processing.
   (7)

The distance measuring device according to (6), in which the weighting processing section performs the weighting processing on the frequency value such that a ratio of the reaction count measurement results among the plurality of pixels becomes the predetermined ratio.

(8)

The distance measuring device according to (7), in which in light receiving processing performed after reference light receiving processing, the weighting processing section performs the weighting processing on the frequency value such that a ratio of the reaction count measurement results among the plurality of pixels is same as a ratio of the reaction count measurement results among the plurality of pixels in the reference light receiving processing.

(9)

The distance measuring device according to (7), in which
the weighting processing section:
performs the weighting processing on the frequency value such that a ratio of the reaction count measurement results among the plurality of pixels becomes a first predetermined ratio in reference light receiving processing; and
performs the weighting processing on the frequency value such that a ratio of the reaction count measurement results among the plurality of pixels becomes the first predetermined ratio in light receiving processing performed after the reference light receiving processing.
   (10)

The distance measuring device according to (8) or (9), in which the reference light receiving processing is calibration of the distance measuring device.

(11)

The distance measuring device according to any one of (6) to (10), in which in second light receiving processing performed after first light receiving processing, the weighting processing section performs the weighting processing on the frequency value in the second light receiving processing on the basis of the reaction count measurement result in the first light receiving processing.

(12)

The distance measuring device according to any one of (6) to (10), further including
a storage control section that stores the count value output from the time counting section in a count value storage section, in which
in third light receiving processing, the weighting processing section performs the weighting processing on the frequency value in the third light receiving processing stored in the count value storage section on the basis of the reaction count measurement result in the third light receiving processing.
   (13)

The distance measuring device according to any one of (6) to (12), further including a determination section that determines whether or not the reaction count measurement result is within a predetermined range.

(14)

The distance measuring device according to any one of (1) to (13), in which the time counting section counts a time from when the light source emits light to the incident timing for each pixel.

(15)

The distance measuring device according to any one of (1) to (14), further including
a first storage section that stores the correction parameter, in which
the processing section performs the correction processing on the basis of the correction parameter stored in the first storage section.
   (16)

A distance measuring system including:
a lighting device having a light source; and
a distance measuring device that receives reflected light in which light from the light source is reflected by an object, in which
the distance measuring device includes:
a time counting section that counts a time from light emission by the light source to an incident timing at which photons are incident on a pixel;
a processing section that performs correction processing on a count value output by the time counting section on the basis of a correction parameter set in advance; and
a histogram generation section that generates a histogram on the basis of the count value corrected by the processing section.
   (17)

The distance measuring system according to (16), in which
the distance measuring device further includes a first storage section that stores the correction parameter, and
the processing section performs the correction processing on the basis of the correction parameter stored in the first storage section.
   (18)

The distance measuring system according to (16), further including
a second storage section that is disposed at a position different from a position at which the lighting device and the distance measuring device are disposed and stores the correction parameter, in which
the processing section performs the correction processing on the basis of the correction parameter stored in the second storage section.
   (19)

The distance measuring system according to (16), in which
the lighting device further includes a third storage section that stores the correction parameter, and
the processing section performs the correction processing on the basis of the correction parameter stored in the third storage section.
   (20)

A distance measuring method including:
counting, by a time counting section, a time from light emission by a light source to an incident timing at which photons are incident on a pixel;
performing, by a processing section, correction processing on a count value output by the time counting section on the basis of a correction parameter set in advance; and
generating, by a histogram generation section, a histogram on the basis of the count value corrected by the processing section.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the contents defined in the claims and equivalents thereof.

### REFERENCE SIGNS LIST

11 Distance measuring system
22 Lighting device
23 Distance measuring device
81 Pixel
81G Pixel group
112 TDC
130 Processing section
132 Histogram generation section
134 Offset storage section
135 Offset compensation section
172 Reaction count measurement section
173 Weight deciding section
1731 Reaction count storage section
174 Weighting processing section
175 Storage control section
1751 TDC code storage section
176 Determination section
177 Notification section
F1 to F4 Frequency value
H Histogram

1. A distance measuring device comprising:
a time counting section that counts a time from light emission by a light source to an incident timing at which photons are incident on a pixel;
a processing section that performs correction processing on a count value output by the time counting section on a basis of a correction parameter set in advance; and
a histogram generation section that generates a histogram on a basis of the count value corrected by the processing section.

2. The distance measuring device according to claim 1, wherein
the processing section includes a compensation section that performs offset compensation processing on the count value output from the time counting section on a basis of an offset of the count value set in advance, and
the histogram generation section generates the histogram on a basis of the count value subjected to the offset compensation processing.

3. The distance measuring device according to claim 2, wherein the compensation section performs the offset compensation processing on the count value output from the time counting section such that the count value at which a frequency value of the count value is maximized is same among a plurality of the pixels.

4. The distance measuring device according to claim 2, wherein the compensation section performs the offset compensation processing for each pixel on a basis of the offset corresponding to each pixel.

5. The distance measuring device according to claim 2, wherein the compensation section performs the offset compensation processing for each pixel group on a basis of the offset corresponding to one pixel included in the pixel group including a plurality of the pixels.

6. The distance measuring device according to claim 1, wherein
the processing section includes:
a measurement section that measures a reaction count that a light receiving element has reacted in response to incidence of photons to the pixel; and
a weighting processing section that performs weighting processing on a frequency value of the count value output by the time counting section on a basis of a reaction count measurement result of the measurement section for each of a plurality of the pixels, the reaction count set in advance, or a predetermined ratio of the reaction count set in advance between the plurality of pixels, and
the histogram generation section generates the histogram on a basis of the frequency value subjected to the weighting processing.

7. The distance measuring device according to claim 6, wherein the weighting processing section performs the weighting processing on the frequency value such that a ratio of the reaction count measurement results among the plurality of pixels becomes the predetermined ratio.

8. The distance measuring device according to claim 7, wherein in light receiving processing performed after reference light receiving processing, the weighting processing section performs the weighting processing on the frequency value such that a ratio of the reaction count measurement results among the plurality of pixels is same as a ratio of the reaction count measurement results among the plurality of pixels in the reference light receiving processing.

9. The distance measuring device according to claim 7, wherein
the weighting processing section:
performs the weighting processing on the frequency value such that a ratio of the reaction count measurement results among the plurality of pixels becomes a first predetermined ratio in reference light receiving processing; and
performs the weighting processing on the frequency value such that a ratio of the reaction count measurement results among the plurality of pixels becomes the first predetermined ratio in light receiving processing performed after the reference light receiving processing.

10. The distance measuring device according to claim 8, wherein the reference light receiving processing is calibration of the distance measuring device.

11. The distance measuring device according to claim 6, wherein in second light receiving processing performed after first light receiving processing, the weighting processing section performs the weighting processing on the frequency value in the second light receiving processing on a basis of the reaction count measurement result in the first light receiving processing.

12. The distance measuring device according to claim 6, further comprising
a storage control section that stores the count value output from the time counting section in a count value storage section, wherein
in third light receiving processing, the weighting processing section performs the weighting processing on the frequency value in the third light receiving processing stored in the count value storage section on a basis of the reaction count measurement result in the third light receiving processing.

13. The distance measuring device according to claim 6, further comprising a determination section that determines whether or not the reaction count measurement result is within a predetermined range.

14. The distance measuring device according to claim 1, wherein the time counting section counts a time from when the light source emits light to the incident timing for each pixel.

15. The distance measuring device according to claim 1, further comprising
a first storage section that stores the correction parameter, wherein
the processing section performs the correction processing on a basis of the correction parameter stored in the first storage section.

16. A distance measuring system comprising:
a lighting device having a light source; and
a distance measuring device that receives reflected light in which light from the light source is reflected by an object, wherein
the distance measuring device includes:
a time counting section that counts a time from light emission by the light source to an incident timing at which photons are incident on a pixel;
a processing section that performs correction processing on a count value output by the time counting section on a basis of a correction parameter set in advance; and
a histogram generation section that generates a histogram on a basis of the count value corrected by the processing section.

17. The distance measuring system according to claim 16, wherein
the distance measuring device further includes a first storage section that stores the correction parameter, and
the processing section performs the correction processing on a basis of the correction parameter stored in the first storage section.

18. The distance measuring system according to claim 16, further comprising
a second storage section that is disposed at a position different from a position at which the lighting device and the distance measuring device are disposed and stores the correction parameter, wherein
the processing section performs the correction processing on a basis of the correction parameter stored in the second storage section.

19. The distance measuring system according to claim 16, wherein
the lighting device further includes a third storage section that stores the correction parameter, and
the processing section performs the correction processing on a basis of the correction parameter stored in the third storage section.

20. A distance measuring method comprising:
counting, by a time counting section, a time from light emission by a light source to an incident timing at which photons are incident on a pixel;
performing, by a processing section, correction processing on a count value output by the time counting section on a basis of a correction parameter set in advance; and
generating, by a histogram generation section, a histogram on a basis of the count value corrected by the processing section.
